(19) United States
(12) Patent Application Publication
(10) Pub. No.: US 2026/0261171 A1
(43) Pub. Date: Sep. 3, 2026

(54) SYSTEMS AND METHODS FOR ACTIVELY COOLING A BOLTED STATOR

(71) Applicant: DANA TM4 INC., Boucherville (CA)

(72) Inventors: Ryan D. NELMS, Weatherford, TX (US); Benjamin POWELL, Austin, TX (US); Darren J. ZISKOVSKY, Bowling Green, OH (US); Maxime MOISAN, Boucherville (CA)

(21) Appl. No.: 19/067,486

(22) Filed: Feb. 28, 2025

(51) Int. Cl. H02K 1/20

(52) U.S. Cl. CPC H02K 1/20

(57) ABSTRACT

Systems and methods are disclosed for actively cooling a bolted stator of an electric motor. In one example, a bolted stator includes bolts extending through lobes, and coolant channels. The coolant channels include a coolant feed channel positioned at a base of each of the lobes, circumferential cross channels positioned at an axial middle of the bolted stator and in fluid communication with the coolant feed channels, and axial channels extending axially from the cross channels to a first end of the bolted stator and a second end of the bolted stator axially opposite the first end. Coolant fluid is flowed through the coolant channels to cool the bolted stator.

### TECHNICAL FIELD

The present description relates generally to actively cooling a bolted stator of an electric machine.

A bolted stator may be used with a rotor in an electric machine to transform energy between electrical and mechanical forms, for example to propel a vehicle. Cooling parts of the electric machine, including the stator, may increase efficiency of energy transfer and extend a lifespan of the electric machine. Press-fit stators may have channels traversing therethrough for active cooling (e.g., pressurized oil flow through the channels). However, bolted stators may conventionally lack active cooling systems due to bolts complicating sealing of coolant channels. Instead, windings of the bolted stator may be passively cooled, for example, by submerging in coolant fluid that does not enter the bolted stator. Absence of active cooling in bolted stators may limit the thermal management capability of electric machines including the bolted stators.

Thus, systems and methods for actively cooling a bolted stator of an electric machine are disclosed herein. In one example, the bolted stator includes a lobe wherethrough a bolt extends; a coolant feed channel positioned at a base of the lobe; circumferential cross channels positioned at an axial middle of the bolted stator and in fluid communication with the coolant feed channel; and axial channels extending axially from the cross channels to each end of the bolted stator, including, a first end and a second end axially opposite of the first end. A press-in-place seal may surround an inlet to the feed channel for sealing of the coolant channels. A coolant distribution element may distribute coolant fluid to the coolant feed channel. In this way, coolant fluid may be actively flowed (e.g., pumped) through the bolted stator and evenly distributed throughout, increasing cooling effectiveness (e.g., heat removed from the bolted stator). Thus, actively cooling the bolted stator may increase power output of an electric machine including the bolted stator while maintaining serviceability. Further, feeding coolant fluid to the cross channels may reduce a temperature difference between ends of the bolted stator, evening out a temperature distribution of the stator to further increase cooling effectiveness.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 schematically shows a system including an electric machine.

FIG. 2 shows a perspective view of a bolted stator of the electric machine.

FIG. 3 shows another view of the bolted stator.

FIG. 4 shows another view of the bolted stator.

FIGS. 5A-5C show views of a coolant distribution component of the electric machine.

FIG. 6 shows a cross sectional view of the coolant distribution component assembled with the bolted stator.

FIG. 7 shows a flowchart of a method for actively cooling the bolted stator.

FIG. 8 shows a bolted stator.

FIG. 9 shows a bolted stator.

FIG. 10 shows a bolted stator.

FIG. 11 shows a cross sectional view of the coolant distribution component assembled with the bolted stator and a gearbox.

FIG. 12 shows a cross sectional view of the coolant distribution component assembled with the bolted stator.

### DETAILED DESCRIPTION

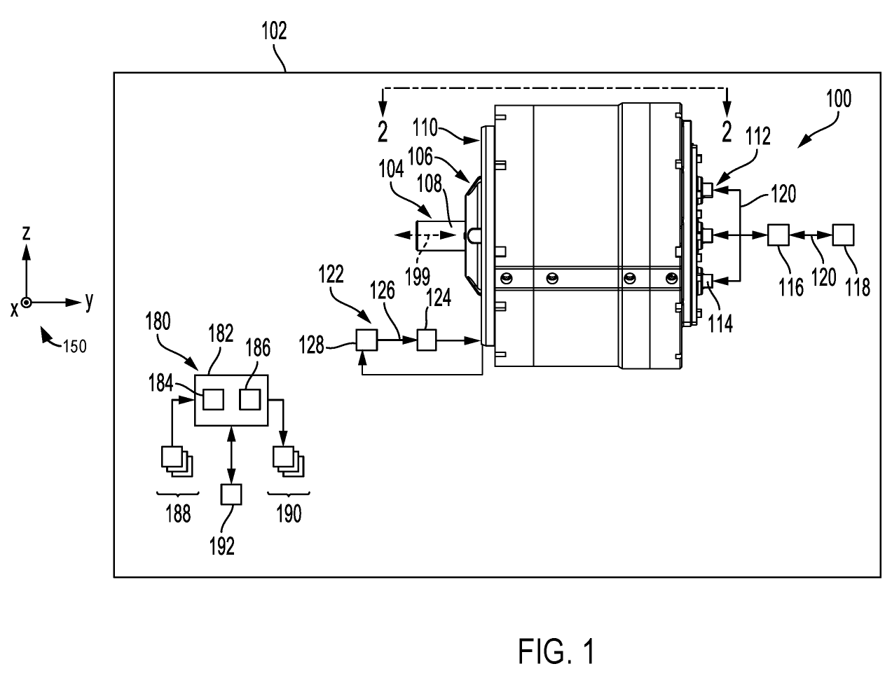

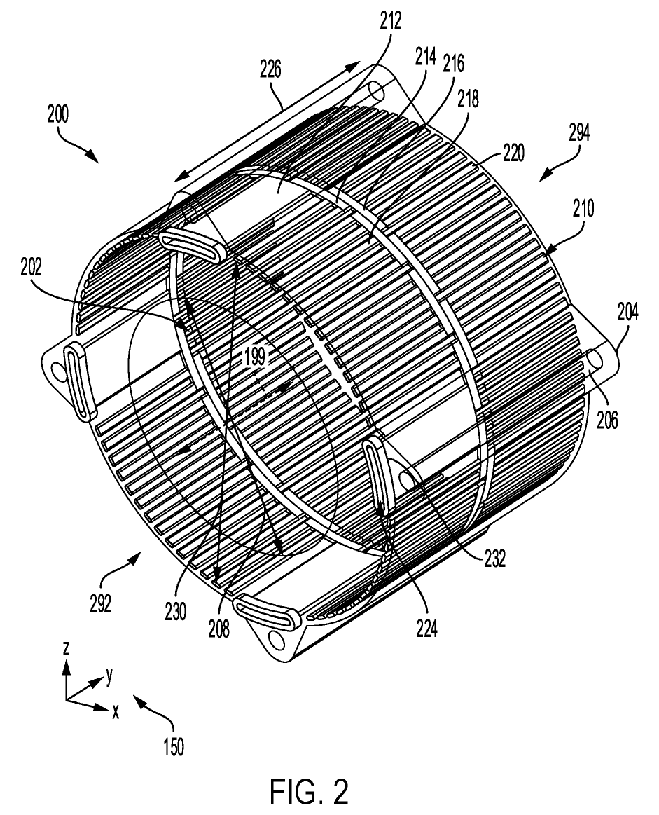

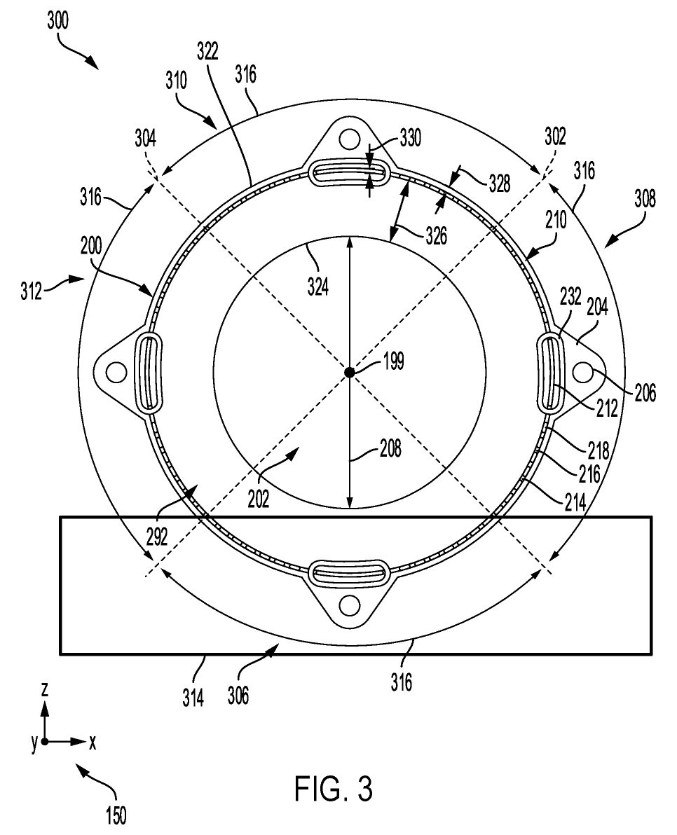

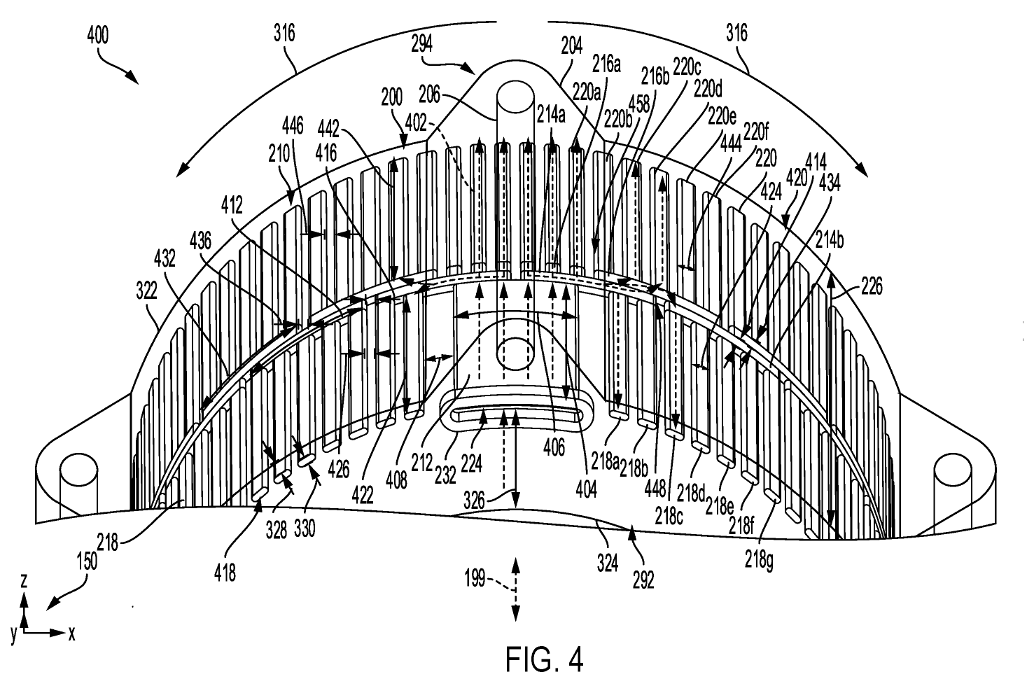

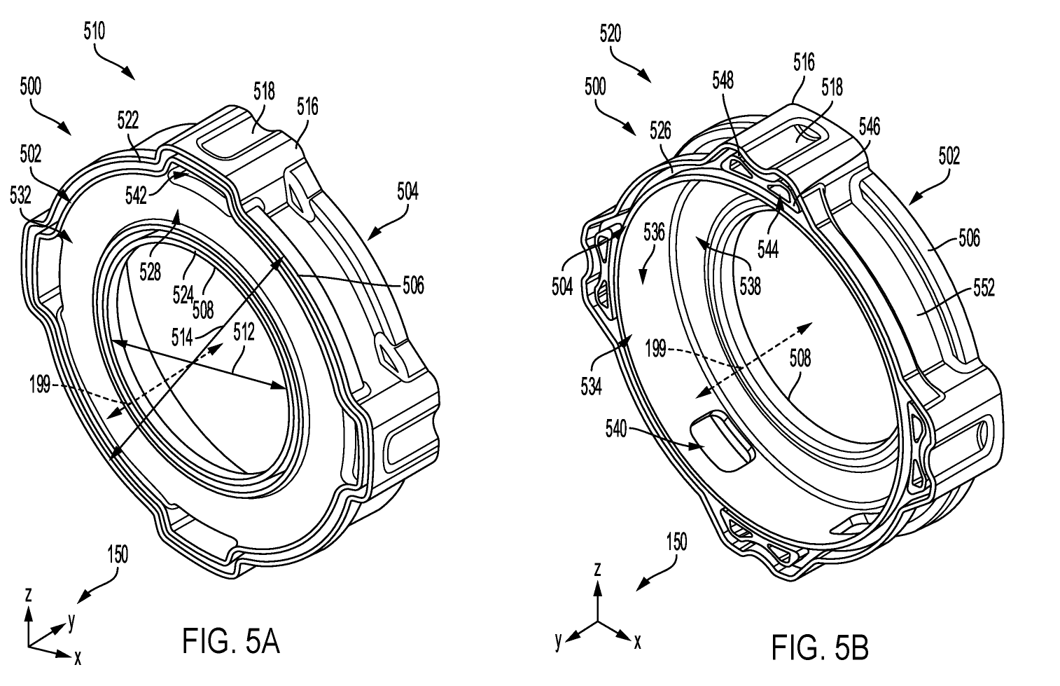

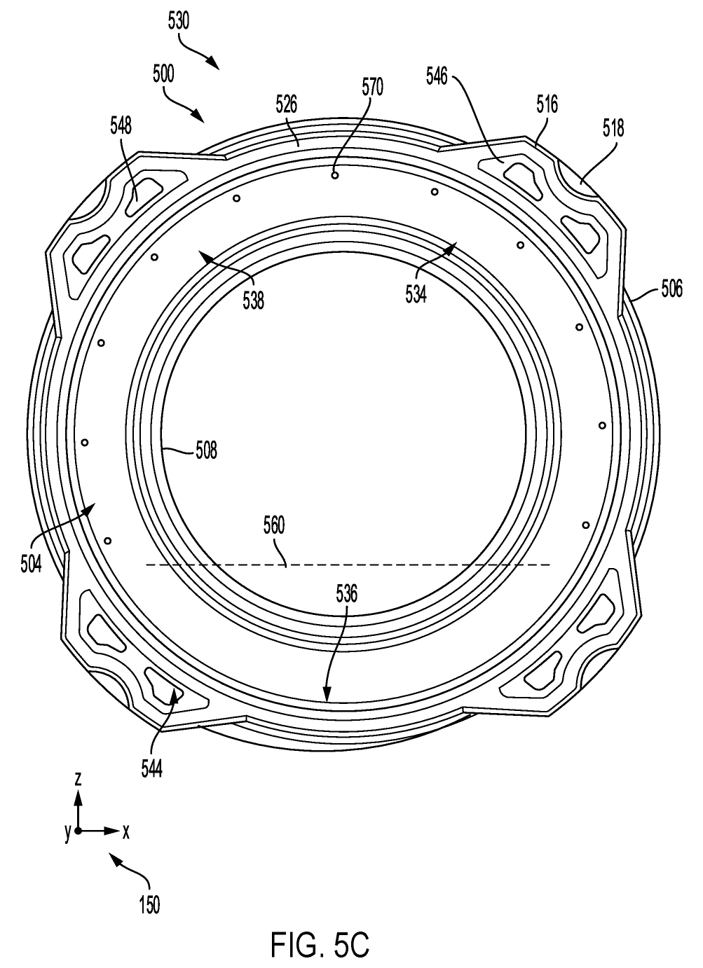

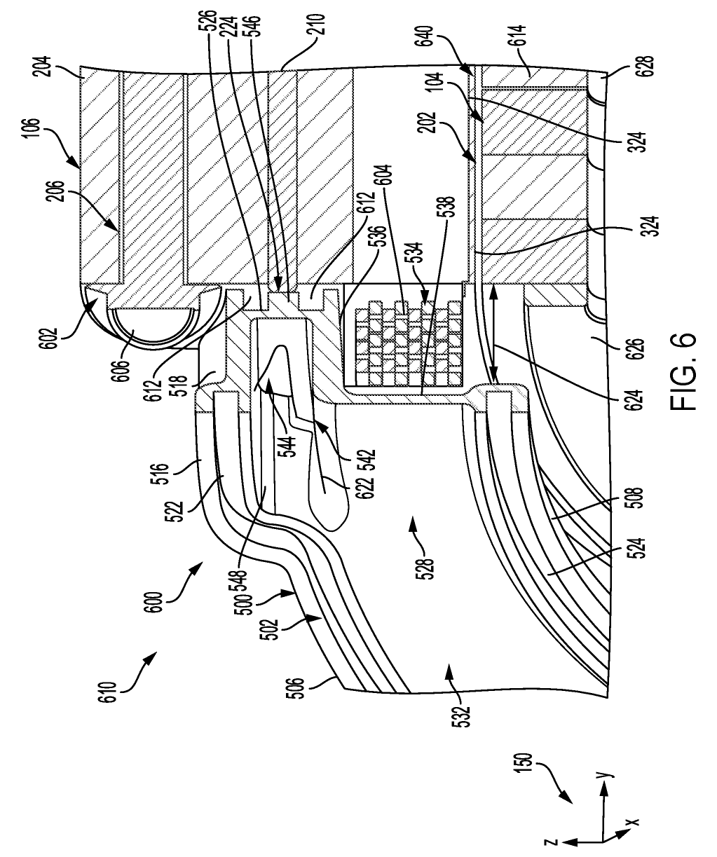

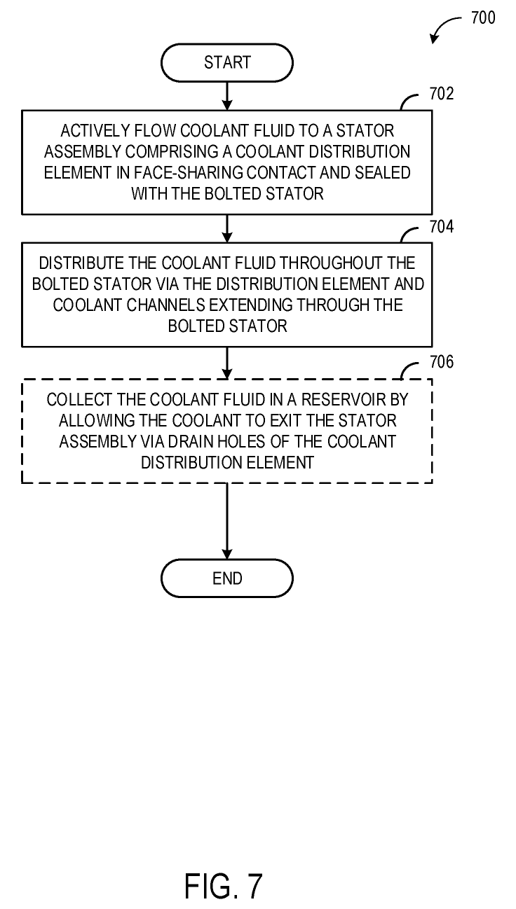

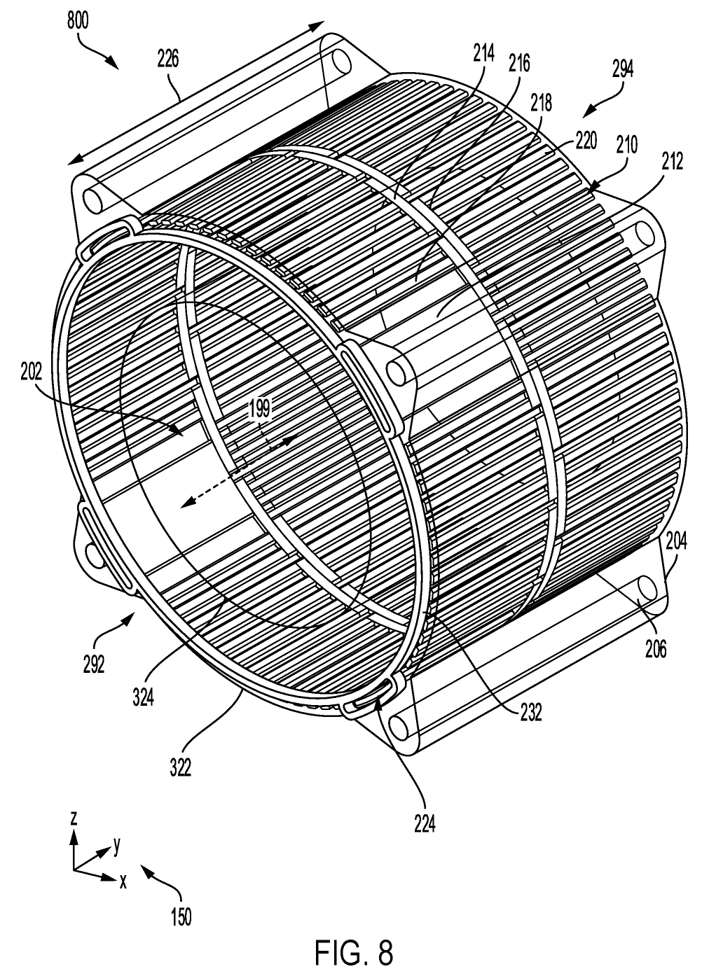

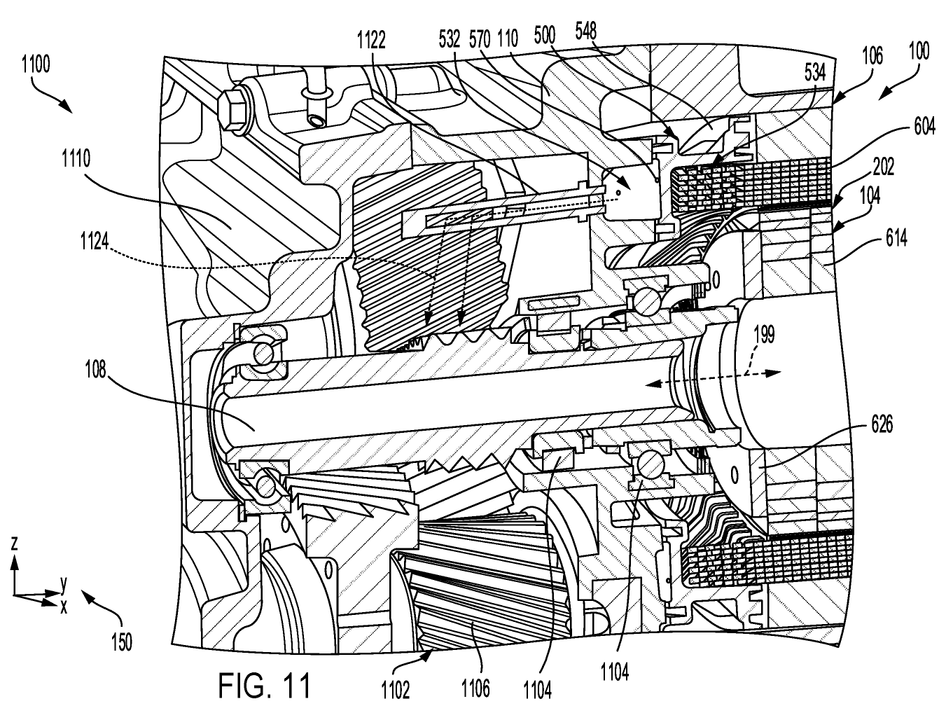

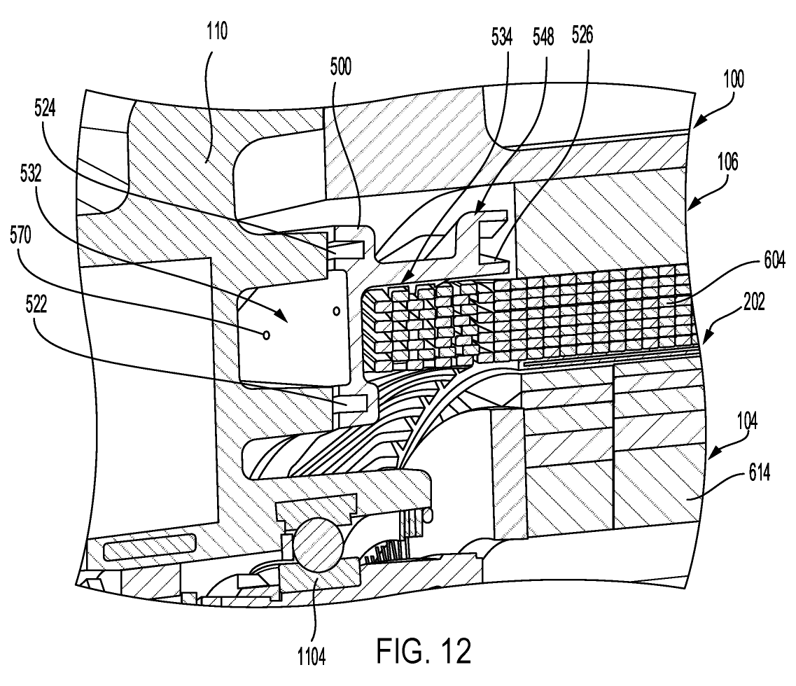

The following description relates to systems and methods for actively cooling a bolted stator of an electric machine. As used herein, a bolted stator may be a stator comprising lamination layers held together via bolts extending through the lamination layers. A schematic of a system including an electric machine having a cooling system is shown in FIG. 1. The electric machine may include a bolted stator, which may be cooled via the cooling system. For example, the cooling system may actively flow coolant fluid into the bolted stator and through coolant channels thereof, including one or more of feed channels, axial channels, and cross channels. An example of the bolted stator, including the coolant channels therein, is shown in a first view in FIG. 2. The bolted stator is further shown in additional views in FIGS. 3 and 4. The electric machine may further include a distribution element adapted to distribute coolant fluid of the cooling system to the feed channels of the bolted stator. An example of the coolant distribution element is shown in FIGS. 5A-5C. Specifically, a housing side of the distribution element is shown in FIG. 5A and a stator side of the distribution element is shown in FIGS. 5B and 5C. The housing side may be positioned in face-sharing contact with a housing of an electric machine, such as the example of FIG. 1, and the stator side may be positioned in face-sharing contact with the bolted stator, such as the bolted stator of FIGS. 2-4, when assembled. A cross sectional view of the distribution element positioned relative to the bolted stator is shown in FIG. 6. A method for cooling a bolted stator in accordance with the present disclosure such as the bolted stator of FIGS. 1-4 and 6 is shown as a flowchart in FIG. 7. The method may include actively flowing coolant fluid through a distribution element as well as channels of the bolted stator, the channels being oriented to facilitate a combination of both axial and circumferential flow paths throughout the bolted stator. FIGS. 8-10 show further examples of the bolted stator of the electric machine of FIG. 1. FIG. 11 shows a subsystem of the system shown in FIG. 1, the subsystem including the coolant distribution element, the electric machine, and a gearbox in accordance with the present disclosure. FIG. 12 shows another view of part of the subsystem of FIG. 11.

It is to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

Turning to FIG. 1, an illustration of an electric machine 100 is shown. A set of reference axes 150, including an x-axis, a y-axis, and a z-axis, are provided in FIG. 1, as well as FIGS. 2-6 and 8-13. The z-axis may be a vertical axis (e.g., parallel to a gravitational axis), the x-axis may be a lateral axis (e.g., horizontal axis), and/or the y-axis may be a longitudinal axis, in one example. Additionally or alternatively, the y-axis may be parallel to an axial direction, while the z-axis and x-axis may be parallel to radial directions. However, the axes may have other orientations, in other examples. A rotational axis 199 is shown in FIG. 1, as well as FIGS. 2-5B and 8-13, as a dashed line, or a dot when oriented perpendicular to the page. The rotational axis 199 may be parallel with the y-axis. Components, dimensions, and directions described herein as axial may be parallel with the rotational axis 199. Components, dimensions, and directions described herein as radial may be radially oriented with respect the rotational axis 199. Components, dimensions, and directions described herein as angular or circumferential may follow curved (e.g., circular) arcs centered around the rotational axis 199 (e.g., positioned with a radius of curvature thereof intersecting the rotational axis).

The electric machine 100 may be designed as an electric motor-generator and may be included in a system 102 which may take a variety forms. For instance, the electric machine 100 may be incorporated into an electric drive system of an electric vehicle (EV), in one example. As such, the electric machine 100 is a traction motor in such an example and the electric drive may further include a transmission (e.g., gearbox), for instance. In the EV example, the EV may be an all-electric vehicle (e.g., a battery electric vehicle (BEV)), in one example, or a hybrid electric vehicle (HEV) with an internal combustion engine, in another example. However, the electric machine 100 may be used in other suitable systems (e.g., stationary systems), in other examples, such as in industrial machines, agricultural systems, mining systems, and the like.

The electric machine 100 includes a rotor 104 that electromagnetically interacts with a stator 106 to drive rotation of a rotor shaft 108. The rotor 104 may be circumferentially surrounded by the stator 106. The stator 106 may be a bolted stator, comprising a plurality of laminations held together in a stack by bolts extending therethrough. Further, the stator 106 may include coolant channels in accordance with the present disclosure wherethrough coolant fluid may flow, as described further below.

The electric machine 100 in the illustrated example includes a housing 110 with an electrical interface 112 for the stator 106. The electrical interface 112 may be a multi-phase electrical interface with multiple electrical connectors 114. The electrical interface 112 is a three-phase interface, in the illustrated example. However, it will be understood that the electrical interface may be a six phase interface or a nine phase interface, in other examples. More generally, the electric machine 100 may be a multi-phase alternating current (AC) machine. However, in other examples, the electric machine 100 may be a direct current (DC) machine.

As illustrated in FIG. 1, the electric machine 100 may be electrically coupled to an inverter 116. The inverter 116 is designed to convert direct current (DC) power to alternating current (AC) power and vice versa. As such, the electric machine 100 may be an AC electric motor, as indicated above. However, in other examples, the electric machine 100 may be a DC electric motor (as previously indicated) and the inverter 116 may therefore be omitted from the system 102. The inverter 116 may receive electric energy from one or more energy storage device(s) 118 (e.g., traction batteries, capacitors, combinations thereof, and the like). Arrows 120 signify the electric energy transfer between the electric machine 100, the inverter 116, and the energy storage device(s) 118 that may occur during different modes of system operation.

The system 102 may additionally include a control sub-system 180 with a controller 182. The controller 182 includes a processor 184 and memory 186. The memory 186 may hold instructions stored therein that when executed by the processor 184 cause the controller 182 to perform the various methods, control techniques, and the like, described herein. The processor 184 may include a microprocessor unit and/or other types of circuits. The memory 186 may include known data storage mediums such as random access memory, read-only memory, keep alive memory, combinations thereof, and the like.

The controller 182 may receive various signals from sensors 188 positioned in different locations in the system 102. The sensors 188 may include an electric machine speed sensor, energy storage device temperature sensor(s), an energy storage device state of charge sensor(s), an inverter power sensor, and the like. The controller 182 may also send control signals to various actuators 190 coupled at different locations in the system 102. For instance, the controller may send signals to the inverter 116 to adjust the rotational speed of the electric machine 100 (e.g., rotational speed of the rotor 104). In another example, the controller 182 may send a command signal to the electric machine 100 and/or the inverter 116 and in response, motor speed may be adjusted. In another example, the controller 182 may send a command signal to a cooling system 122, for instance to adjust a flow rate of coolant fluid delivered to the electric machine 100. The other controllable components in the system 102 may function in a similar manner with regard to command signals and actuator adjustment.

The system 102 may also include one or more input device(s) 192 (e.g., an accelerator pedal, a brake pedal, a console instrument panel, a touch interface, a touch panel, a keyboard, combinations thereof, and the like). The input device(s) 192 may generate a motor speed adjustment request responsive to user input.

The cooling system 122 may be configured to cool the rotor 104 and/or the stator 106. For example, the cooling system 122 may deliver coolant fluid (e.g., oil) to the electric machine 100. More specifically, the cooling system 122 may deliver coolant fluid to coolant channels formed in the stator 106 via a coolant pressurizing component 124 (e.g., pump). The cooling system 122 may include a reservoir 128 where the coolant fluid may be stored when not flowing through the electric machine 100. The reservoir 128 may include a sump positioned below the stator 106, in some examples. The coolant pressurizing component 124 may pump fluid from the reservoir 128 into the electric machine 100. Arrows 126 show pathways of coolant fluid, including from the reservoir 128 to the electric machine 100 via the coolant pressurizing component 124. The coolant fluid may flow passively back to the reservoir 128 (e.g., after exiting the stator 106), as indicated by the arrows 126. In this way, the coolant fluid may flow through the system 102 in a cyclical manner. The coolant fluid may flow through coolant channels in the stator 106, as described further below. The coolant fluid may further flow through a coolant distribution element interposed between the housing 110 and the stator 106. For example, coolant fluid may flow through the coolant distribution element prior to the channels of the stator 106 in order to provide even distribution of coolant flow rates throughout the stator 106. Upon exiting the stator 106, the coolant fluid may cool ends of windings of the stator 106. Actively cooling the stator 106 in such a way may increase heat removed from the stator 106 compared to other cooling methods for bolted stators (e.g., passive cooling).

Turning to FIG. 2, an example of a bolted stator 200 is shown. The bolted stator 200 may be an example of the stator 106 of FIG. 1. The bolted stator 200 is shown partially translucent to avoid visual obstruction of internal structures including coolant channels described herein. Though not shown as individual components, the bolted stator 200 may comprise a plurality of lamination layers oriented in x-z planes and stacked together from a first end 292 of the bolted stator 200 to a second end 294 of the bolted stator 200. Further, the lamination layers may be held together via bolts (e.g., bolt 602 shown in FIG. 6) extending axially therethrough as described further below.

The lamination layers may be coaxially stacked along the rotational axis 199. A length 226 of the bolted stator 200 between the first end 292 and the second end 294 may depend on the number of lamination layers and the axial thickness of each layer. The lamination layers may include central holes defined by inner perimeters of the lamination layers, the central holes being circular-shaped with a bore diameter 208. Thus, the lamination layers may be generally annular-shaped with an outer diameter 230. The central holes may axially align to form a cylindrical bore 202 with the bore diameter 208, the bore 202 extending centrally and axially through the bolted stator 200 between the first end 292 to the second end 294. The bore 202 may be circumferentially surrounded by the lamination layers and adapted to receive a rotor, such as the rotor 104 of FIG. 1. The bore 202 may be open at the first end 292 and the second end 294 such that the bore 202 is configured as a through-hole of the bolted stator 200.

The bolted stator 200 may include two or more lobes 204, each having a through-hole 206 wherethrough a bolt (e.g., bolt 602 of FIG. 6) may extend. The lobes 204 may be triangular shaped with rounded corners. In other examples, the lobes 204 may be rectangular, trapezoidal, semicircular, or other shapes. The lobes 204 may be formed by axially aligning outer perimeters of the lamination layers which may be identical to one another. Likewise, the through-holes 206 may be defined by holes in each of the lamination layers being axially aligned (e.g., axially overlapping), where the holes may be identically shaped and arranged relative to the outer perimeters of the lamination layers to allow such axial alignment. The lobes 204 may extend radially outward from the annular portion of the bolted stator 200. There may be four of the lobes 204, as shown in FIG. 2; though in other examples, there may be more or fewer lobes 204 than four, radially arranged equidistantly along a perimeter (e.g., outer perimeter) of the bolted stator 200. There may be an even number of lobes 204 with pairs located diametrically across from each other such that the bolted stator 200 is symmetric, for example.

The bolted stator 200 may further include a plurality of coolant channels 210 wherethrough coolant fluid may flow through the bolted stator 200. The coolant channels 210 may be positioned and shaped to passively direct (e.g., distribute) the coolant fluid throughout the bolted stator 200. The coolant channels 210 may include one or more of feed channels 212, first cross channels 214, second cross channels 216, first axial channels 218, and second axial channels 220. As used herein, feed channels such as the feed channels 212 may be channels wherethrough coolant may enter the bolted stator 200. As used herein, cross channels such as the first and second cross channels 214, 216 may be channels wherethrough coolant fluid flows circumferentially through the bolted stator 200. As used herein, axial channels such as the first and second axial channels 218, 220 may be channels wherethrough coolant fluid flows axially through the bolted stator 200 and/or fluid may exit the bolted stator 200. Though at least some of the coolant channels 210 are continuous with each other, segments between points where fluid flow direction may be rerouted (e.g., from an axial direction to a circumferential direction or vice versa) are conceptually described herein as individual channels.

The first axial channels 218 may be positioned closer to the first end 292 than the second axial channels 220. Thus, the second axial channels 220 may be positioned closer to the second end 294 than the first axial channels 218. Likewise, the first cross channels 214 may be positioned closer to the first end 292 than the second cross channels 216, which may therefore be positioned closer to the second end 294 than the first cross channels 214.

Coolant may enter the bolted stator 200 via coolant feed channels 212. Specifically, coolant may be delivered to the coolant feed channels 212 via inlets 224 located at the first end 292. One of the coolant feed channels 212 may be positioned at the base of each of the lobes 204 (e.g., in proximity to the radial position where the lobes 204 extend radially outward). In this way, the coolant feed channels 212 may be evenly circumferentially distributed. A protrusion 232 may surround each inlet 224. For example, the protrusions 232 may encircle the inlets 224 in a rounded shape such as a ring, oval, or other elongated curved shape. The protrusion 232 may be integral with the lamination layers of the bolted stator 200, for example. As an example, the protrusion 232 may be part of a press in place seal configured to maintain a seal (e.g., hermetic seal) without fasteners. For example, the protrusion 232 may be complementarily shaped to a groove adapted to receive the protrusion 232 in an interference fit, such as a groove of a coolant distribution element (e.g., coolant distribution element 500). The protrusion 232 may be larger than the inlet 224 such that the protrusion 232 is spaced away from the inlet 224. The protrusion 232 may further be spaced away from the through-hole 206 and the outer perimeter of the bolted stator 200 (e.g., outer edges of the lobe 204).

In some examples, the protrusions 232 may be interconnected and/or may further extend in a ring along the outer perimeter of the stator 200. To illustrate, briefly referencing FIG. 8, a bolted stator 800 is shown with the protrusion 232 being a single integral protrusion comprising a ring radially inward of the outlets and concentric with the lamination layers of the stator 800. The protrusion 232 further comprises loops around each of the inlets 224 as described above. The protrusion 232 may fit with a complementary groove in a surface (e.g., of a housing or baffle) to form a press in place seal between the stator 800 and the surface. In this way, the bore 202 may be sealed from the fluid entering and exiting the bolted stator 800 via the coolant channels 210. Therefore, the coolant fluid may not be allowed to contact the rotor (e.g., rotor 104 of FIG. 1) positioned within the bore 202, preventing drag losses on rotation of the rotor.

Returning to FIG. 2, coolant fluid may exit the bolted stator 200 via the first axial channels 218 and the second axial channels 220. The first axial channels 218 may open to the first end 292 and the second axial channels may open to the second end 294. Thus, coolant fluid may exit the bolted stator 200 at both ends 292, 294. The coolant fluid may flow directly into a sump below the bolted stator 200. Alternatively, as described further below, the coolant fluid may flow through shower head baffles (e.g., baffles with a plurality of holes shaped and arranged similar to jets of a showerhead), positioned at one or both of the first end 292 and the second end 294, after exiting the bolted stator 200 via the axial channels 218, 220 such that the coolant fluid is sprayed towards windings of the bolted stator on both ends 292, 294 before accumulating in a sump (e.g., reservoir 128 of FIG. 1) which may be positioned below the bolted stator 200.

Turning to FIG. 3, an axial view 300 of the bolted stator 200 looking at the first end down the rotational axis 199 is shown. The bolted stator 200 may be symmetrical across one or more radially oriented planes, such as a first plane 302 and a second plane 304. The first plane 302 and the second plane 304 may conceptually divide the bolted stator 200 into four sectors, including a first sector 306, a second sector 308, a third sector 310, and a fourth sector 312. The sectors may be identical to each other, in some examples. In this way, inversion of the lamination layers or other orientation errors may be prevented when stacking the lamination layers to form the bolted stator 200. Additionally, each of the sectors may include a single lobe 204 and accordingly a single feed channel 212. The sectors may be fluidly coupled to each other via the cross channels 214, 216. Alternatively, the sectors may be fluidly separated from one another by forming a gap in the cross channels 214, 216 between adjacent sectors (e.g., along the symmetry planes such as planes 302, 304).

The coolant channels 210 may be arranged in a ring centered about the rotational axis 199 and in proximity to an outer perimeter 322 of the bolted stator 200, compared to an inner perimeter 324 of the bolted stator 200. That is, a radial distance 326 between the inner perimeter 324 and the coolant channels 210 may be greater than a radial distance 328 between the coolant channels 210 and the outer perimeter 322, excluding coolant channels radially adjacent to the lobes 204 (e.g., radially interposed between the lobes 204 and the inner perimeter 324) such as the feed channels 212 due to the outer perimeter 322 jutting radially outward at the lobes 204. Further, a radial thickness 330 of each of the coolant channels 210 may be approximately the same, in at least some examples.

However, shapes and/or sizes of some of the coolant channels 210 may vary within each sector. For example, sizes (e.g., cross sectional areas in x-z planes) of the coolant channels 210 may increase in directions moving further from the inlets 224 indicated by arrows 316 such that flow rate of the coolant fluid is more even throughout the bolted stator 200. To elaborate, the channels at the planes 302, 304 may have larger cross sectional areas than the channels near the inlets 224. Increasing the sizes of the coolant channels 210 in such a manner may encourage fluid to flow at more equal volumetric flow rates throughout the bolted stator 200 by counteracting pressure loss increasing with coolant path distance.

Further, in some examples, a portion of the bolted stator 200 may be submerged in fluid accumulated in the sump, as indicated by a region 314. Less coolant fluid flowing in the coolant channels in that portion may therefore be adequate to achieve the same temperature as sectors not submerged in coolant fluid. As such, the coolant channels 210 positioned in the region 314 (e.g., coolant channels of the first sector 306) may be smaller (e.g., may have smaller x-z cross sectional areas) than the coolant channels 210 positioned outside of the shaded region 314 (e.g., coolant channels of the second, third, and fourth sectors 308, 310, 312). In this way, additionally or alternatively to shapes and/or sizes of at least some of the coolant channels 210 varying within each sector as described above, the shapes and/or sizes may vary between sectors. In this way, flow of coolant fluid through the coolant channels 210 may be adjusted to equalize cooling throughout the bolted stator 200. To elaborate, flow rate of the coolant fluid may be manipulated via the variations in channels such that the bolted stator 200 is cooled relatively evenly throughout, rather than some portions being cooled more than others leading to fluctuating and/or irregular temperatures.

Turning to FIG. 4, a closer view 400 of part of the bolted stator 200 is shown, including example coolant pathways indicated by dashed arrows 402. The coolant pathways shown in FIG. 4 are not exhaustive and it is understood that the coolant may flow similarly throughout all of the coolant channels 210. That is, the arrows 402 show general directions wherein coolant fluid flows through each of the coolant channel types (e.g., the feed channels 212, first cross channels 214, second cross channels 216, first axial channels 218, and second axial channels 220).

Cross sections of the coolant channels 210 in x-z planes may be oval shaped, other curved elongated shapes, or a mixture thereof, as described further below. For example, each of the coolant channel types (e.g., feed channels, axial channels, and cross channels) may be shaped and/or oriented differently from each other.

When used herein to describe the coolant channels 210, a length may be a dimension of the referenced channel parallel with a flow direction of coolant fluid flow through the referenced channel, and a width may be a dimension of the referenced channel perpendicular to the flow direction therethrough.

The feed channels 212 may extend from the inlets 224 towards the second end 294 by an axial length 404 less than the axial length 226 of the bolted stator 200. For example, the axial length 404 may be approximately half the axial length 226, or shorter. The feed channels 212 may be elongated and curved along circular arcs in x-z cross sections. For example, the feed channels 212 may extend circumferentially by an angular width 406. The angular width 406 may be approximately the same as the axial length 404. Cross sections of the feed channels 212 in x-z planes may be elongated shapes curved about the rotational axis 199 with a radius of curvature equal to the radial distance between the feed channels 212 and the rotational axis 199. In this way, along up to the entire angular width 406, the feed channels 212 may be approximately the same radial distance 326 from the inner perimeter 324, as described above.

Further, the feed channels 212 may be radially aligned with one or more of the lobes 204, the through-holes 206, and the protrusions 232. For example, a line extending from the rotational axis 199 radially outward (e.g., vertically upward) may intersect one of the lobes 204, one of the through-holes 206, one of the protrusions 232, and one of the feed channels 212. The feed channels 212 may each be further positioned at the base of the corresponding lobe 204 such that the feed channel 212 may be radially interposed between the lobe 204 and the inner perimeter 324. Additionally, the feed channel 212 may be radially interposed between the through-hole 206 and the inner perimeter 324. Thus, the feed channels 212 may be positioned radially inward relative to the lobes 204, the through-holes 206, and the bolts (e.g., bolt 602 of FIG. 6) extending therethrough. Such a position may provide sufficient surface area around the inlets 224 for the protrusion 232 to be applied thereon (e.g., pressed in place on the axial facing surface of the stator 200 at the first end 292). Further, such positioning of the feed channels 212 may result in the feed channels 212 being evenly circumferentially distributed, allowing for relatively even fluid distribution upon entering the stator 200 via the inlets 224.

From the coolant feed channels 212, coolant fluid may flow into the first cross channels 214 directly fluidly coupled to the coolant feed channels 212, such as first cross channel 214a. As used herein, channels described as directly fluidly coupled may be fluidly coupled (e.g., in fluid communication) and may share an opening such that fluid flowing between the referenced channels does not pass through other channels between the reference channels. Up to all of the coolant channels 210 may be interconnected so as to be in fluid communication with each other; though each of the coolant channels 210 may be directly fluidly coupled to one or more (e.g., more than one but less than all) of the other coolant channels 210, as described further below.

The first cross channels 214 may extend circumferentially by an angular length 412. The angular length 412 may be the same for each of the first cross channels 214 or may be vary between the first cross channels 214. An axial width 414 of the first cross channels 214 may be the same throughout the bolted stator 200, in at least some examples. A distance 416 between adjacent first cross channels 214 may be uniform such that the first cross channels are evenly circumferentially distributed, in at least some examples. The distance 416 may be shorter than the length 412 and/or the width 414.

The first cross channels 214 may each be directly fluidly coupled to one or more first axial channels and one or more second cross channels 216. Some of the first cross channels 214, such as the first cross channel 214a, may further be directly fluidly coupled to one of the feed channels 212. However, fluid may not be allowed to backflow (e.g., reverse flow to out of the inlet 224). The angular length 412 may be sufficiently long to intersect more than one of the coolant channels 210 (e.g., more than one of the first axial channels 218, the second cross channels 216, and/or the feed channels 212), so as to directly fluidly couple to the more than one channel, thereby providing more than one coolant fluid pathway from each of the first cross channels 214. To elaborate, at least some of the first cross channels 214 may be directly fluidly coupled to two or more of the second cross channels 216. For example, the first cross channel 214a is shown directly fluidly coupled to more than two of the second cross channels 216, including second cross channel 216a and second cross channel 216b. Additionally or alternatively, at least some of the first cross channels 214 may be directly fluidly coupled to two or more of the first axial channels 218. For example, the first cross channel 214a is shown directly fluidly coupled to first axial channel 218a and first axial channel 218b. The first cross channels 214 may not be directly fluidly coupled to any of the second axial channels 220. For example, to flow from one of the first cross channels 214 to one of the second axial channels 220, coolant fluid may flow through at least one of the second cross channels 216. As such, from the first cross channels 214, coolant fluid may flow into the first axial channels 218 and the second cross channels 216 directly fluid coupled thereto.

The first axial channels 218 may extend axially by an axial length 422 from the first cross channels 214. A width 424 of the first axial channels 218 may be tangential or circumferential, according to the shape of the first axial channels 218. For example, the first axial channels 218 may curve circumferentially like the feed channels 212 in some examples, such that the width 424 is measured circumferentially. In another example, such as where the first axial channels 218 are sufficiently smaller, the first axial channels 218 may not be curved circumferentially, and thus the width 424 may be measured tangentially to the ring of coolant channels 210. A distance 426 between circumferentially adjacent pairs of the first axial channels 218 may be approximately the same as the distance 416 between circumferentially adjacent pairs of the first cross channels 214. Additionally or alternatively, a distance 408 between the feed channels 212 and the nearest first axial channels 218, such as the first axial channel 218a, may be greater than the distance 426 between adjacent first axial channels 218. The distance 426 may be shorter than the length 422 and/or the width 424.

The first axial channels 218 may be arranged in groups which are directly fluidly coupled to the same one of the first cross channels 214. For example, the first axial channel 218a and the first axial channel 218b may be part of a group of first axial channels 218 directly fluidly coupled to the second cross channel 216a. As another example, first axial channel 218c, first axial channel 218d, first axial channel 218e, first axial channel 218f, and first axial channel 218g may be part of a group of the first axial channels 218 directly fluidly coupled to the first cross channel 214b. The first axial channels 218 at the ends of their respective groups may be flush with lengthwise ends (e.g., ends opposite each other along the length 412) of the respective first cross channels 214. For example, an end of the first axial channel 218b may be flush with (e.g., not circumferentially offset from) a lengthwise end of the first cross channel 214a such that there is a continuous wall 448 formed by the first cross channel 214a and the first axial channel 218b. Likewise, the first axial channel 218c and the first axial channel 218g may be flush with opposing lengthwise ends of the first cross channel 214b.

The first axial channels 218 may each be directly fluidly coupled to only one of the first cross channels 214, and none of the second cross channels 216 or the second axial channels 220. As such, from the first axial channels 218, the coolant fluid may exit the bolted stator 200 via outlets 418. The outlets 418 may be openings at the first end 292 fluidly coupling the first axial channels 218 to the space outside the stator 200. Thus, all coolant fluid flowing in the first axial channels 218 may flow from the corresponding first cross channels 214 towards the first end 292 (e.g., in a negative y-direction) and out of the outlets 418.

The second cross channels 216 may extend circumferentially by an angular length 432. Thus, the second cross channels 216 may be parallel with the first cross channels 214. The angular length 432 may be different between second cross channels 216. That is, some of the second cross channels 216 may be longer than others of the second cross channels 216. For example, a second cross channel 216a may be shorter than a second cross channel 216b. More specifically, second cross channels 216 in proximity to the feed channels 212 may be shorter than second cross channels 216 positioned further form the feed channels 212. Fluid may flow counterclockwise or clockwise through each of the cross channels 214, 216. In some of the second cross channels 216, the fluid may flow axially, such as through the second cross channel 216a. An axial width 434 of the second cross channels 216 may be approximately the same as the axial width 414 of the first cross channels 214. A distance 436 between adjacent pairs of the second cross channels 216 may be approximately the same throughout the stator 200. The distance 436 may be shorter than the length 432 and/or the width 434. Additionally or alternatively, the distance 436 may be equal to one or both of the distances 416 and 426 between the first cross channels 214 and the first axial channels 218, respectively.

The angular length 432 may be sufficiently long to intersect one or more of the coolant channels 210 (e.g., one or more of the second axial channels 220 and/or the second cross channels 216), so as to directly fluidly couple to one or more channels, thereby providing one or more coolant fluid pathways from each of the second cross channels 216. To elaborate, the second cross channels 216 may be directly fluidly coupled to one or more of the first cross channels 214. For example, the second cross channel 216a is shown directly fluidly coupled to first cross channel 214a and no other channels of the first cross channels 214. As another example, second cross channel 216b is shown directly fluidly coupled to more than one (e.g., two) of the first cross channels 214, including the first cross channel 214a and first cross channel 214b.

In this way, the first cross channels 214 may be circumferentially offset from the second cross channels so as to each axially overlap with two or more of the second cross channels 216. Components described as being circumferentially offset from each other may be located at different radial positions. For example, the gaps (e.g., gaps having the distance 416) between the first cross channels 214 may be circumferentially offset from the gaps (e.g., gaps having the distance 436) between the second cross channels 216. Examples of groups of components not circumferentially offset from each other may include two or more of the feed channels 212, the through-holes 206, the lobes 204, and the protrusion 232; and the second cross channel 216a and second axial channel 220a.

Additionally or alternatively, the first cross channels 214 may each be directly fluidly coupled to one or more of the first axial channels 218. For example, the second cross channel 216a is shown directly fluidly coupled to second axial channel 220a, and no other channels of the second axial channels 220. As another example, the second cross channel 216b is shown directly fluidly coupled to five of the second axial channels 220. The second cross channels 216 may not be directly fluidly coupled to any of the first axial channels 218. For example, to flow from one of the second cross channels 216 to one of the first axial channels 218, coolant fluid may flow through at least one of first cross channels 214 therebetween. As such, from the second cross channels 216, the coolant fluid may flow into the second axial channels 220 and the first cross channels 214 directly fluidly coupled thereto. In this way, fluid may weave back and forth between the first cross channels 214 and the second cross channels 216 while flowing generally in the directions indicated by the arrows 316, away from the inlets 224 and/or the lobes 204. Like the first axial channels 218 branching axially from the first cross channels 214, the second axial channels 220 may branch off from the second cross channels 216 towards outlets 420 at the second end 294.

The second axial channels 220 may extend axially from the second cross channels 216 to the second end 294 by an axial length 442, which may be the same for each of the second axial channels 220. A width 444 (e.g., circumferential or tangential width similar to the width 424 described above) may be the same for each of the second axial channels 220 or may increase in the directions indicated by the arrows 316, as described above. A distance 446 between adjacent pairs of the second axial channels 220 may be the same throughout the stator 200 or may vary. For example, the second axial channels 220 with larger widths 444 may be closer together (e.g., spaced by a smaller distance 446), in some examples. The axial length 442 may be equal to the axial length 404 and/or the axial length 422 of the feed channels 212 and the first axial channels 218, respectively. In such an example, the cross channels 214, 216 may be positioned at an axial middle of the bolted stator 200. That is, the cross channels 214, 216 may be interposed between the axial channels 218, 220 at an axial position that is a midpoint of the length 226. Additionally or alternatively, the width 444 may be equal to the width 424 of the first axial channels 218. Thus, some or all of the first axial channels 218 may be identical to some or all of the second axial channels 220.

Like the first axial channels 218, the second axial channels 220 may be arranged in groups which are directly fluidly coupled to the same one of the second cross channels 216. For example, second axial channel 220b, second axial channel 220c, second axial channel 220d, second axial channel 220e, and second axial channel 220f may be part of a group of the second axial channels 220 directly fluidly coupled to the second cross channel 216b. The second axial channels 220 at the ends of their respective groups may be flush with lengthwise ends (e.g., ends opposite each other along the length 432) of the respective second cross channels 216. For example, an end of the second axial channel 220b may be flush with (e.g., not circumferentially offset from) a lengthwise end of the second cross channel 216b such that there is a continuous wall 458 formed by the second cross channel 216b and the second axial channel 220b. Further, the second axial channel 220b and the second axial channel 220f may be flush with opposing lengthwise ends of the second cross channel 216b. Additionally, some of the second cross channels 216 may be directly fluidly coupled to a single one of the second axial channels 220. Fluid may flow axially through such second axial channels 220 as shown through the second axial channel 220a.

The first cross channels 214 and the second cross channels 216 may be circumferentially offset to each other. For example, the widths 424, 444 may not axially align end to end; though they may overlap by less than the full widths 424, 444. This may be due at least in part to the cross channels 214, 216 being circumferentially offset from each other. For example, because some of the axial channels 218, 220 may be flush with lengthwise ends of the respective cross channels 214, 216 and the gaps between the cross channels 214, 216 may be circumferentially offset as described above, the axial channels 218, 200 may be circumferentially offset from each other.

The second axial channels 220 may each be directly fluidly coupled to only one of the second cross channels 216, and none of the first cross channels 214 or the first axial channels 218. As such, from the second axial channels 220, the coolant fluid may exit the bolted stator 200 via the outlets 420, similar to the outlets 418 of the first axial channels 218. Thus, all coolant fluid flowing in the second axial channels 220 may flow from the corresponding second cross channels 216 towards the second end 294 (e.g., in a positive y-direction).

The proportions (e.g., relative volumes) of the coolant fluid that flow down each pathway through the bolted stator 200 may be more even due to variations in channels sizes described above with regard to FIG. 3. Therefore, differences between volumetric flow rates of coolant fluid exiting the bolted stator at each of the outlets 418, 420 may be reduced. It may be that increasing cross sectional areas of the axial channels 218, 220 is achieved by increasing the widths 424, 444 thereof. Additionally or alternatively, distances 426, 446 between the axial channels 218, 220 may be smaller between pairs of larger channels than between pairs of relatively smaller channels.

In this way, the configurations of the coolant channels 210 including both axially and circumferentially oriented channels may provide a more effective cooling system, especially for relatively long stators (e.g., having longer axial lengths 226), by reducing the temperature delta from one end of the stator to the other (e.g., difference in temperature between the first end 292 and the second end 294) due to heat transfer between the coolant fluid and the stator 200. For example, including the cross channels 214, 216 may distribute coolant fluid in pathways that result in a more even temperature distribution.

The coolant channels 210 may be formed by stacking lamination layers with accordingly positioned holes. For example, a first section of lamination layers may have a first hole pattern that forms the coolant feed channels 212 and the first axial channels 218 when stacked with x-z cross sectional areas overlapping; a second section of lamination layers may have a second hole pattern that forms the first cross channels 214 when stacked with x-z cross sectional areas overlapping; a third section of lamination layers may have a third hole pattern that forms the second cross channels 216 when stacked with x-z cross sectional areas overlapping; and a fourth section of lamination layers may have a fourth hole pattern that forms the second axial channels 220 when stacked with x-z cross sectional areas overlapping. The hole patterns may include through-holes in the lamination layers shaped as the x-z cross sections of the respective channels. The first section, the second section, the third section, and the fourth section may be axially stacked in the listed order such that the coolant channels 210 are arranged as described above. Thus, the axial length 404 may be the same for each of the feed channels 212, the axial length 422 may be the same for each of the first axial channels 218, the axial length 442 may be the same for each of the second axial channels 220, the axial width 414 may be the same for each of the first cross channels 214, and/or the axial width 434 may be the same for each of the second cross channels 216.

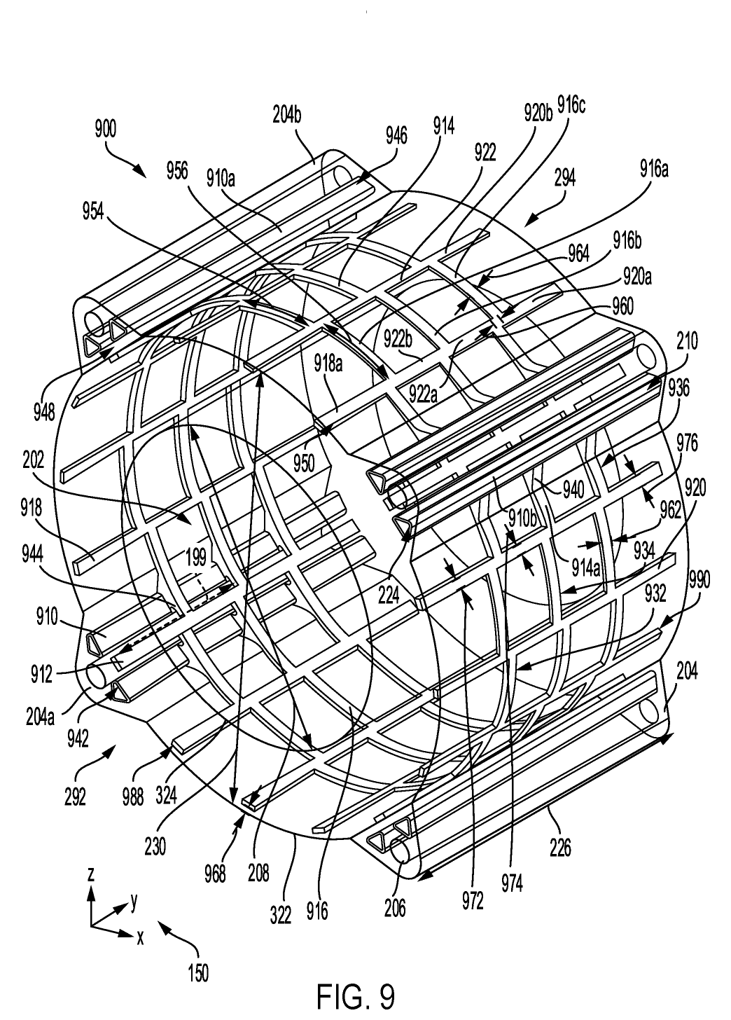

Turning now to FIG. 9, a bolted stator 900, another example of the stator 106 of FIG. 1, is shown. Compared to the stator 200, the stator 900 includes a different arrangement of the coolant channels 210. In the stator 900, the coolant channels 210 include axial and circumferential channels interconnected in a different pattern than the stator 200. In this way, coolant fluid may be routed throughout the stator in different pathways.

The coolant channels 210 may include first feed channels 910 and second feed channels 912. Like the feed channels 212 of the stator 200, coolant may enter the stator 900 through the feed channels 910, 912. The feed channels 910, 912 may extend axially entirely through the stator 900, between the first end 292 and the second end 294, such that the feed channels 910 are open on both the first end 292 and the second end 294.

There may be two of the first feed channels 910 per lobe 204. The two first feed channels 910 may be located opposite each other across the corresponding through-hole extending through the lobe 204. The feed channels 910 may have triangular shaped cross sections with rounded corners. However, other cross-sectional shapes of the feed channels 910 are possible, according to the geometry of the lobes 204. That is, the feed channels 910 may be shaped to maximize the cross sectional area thereof while maintaining a sufficient thickness surrounding the feed channels 910 (e.g., distance from inner wall of the feed channels 910 to the outer perimeter 322 of the lobe 204 and to the inner wall of the through-hole 206).

There may be one of the second feed channels 912 per lobe 204. Additionally or alternatively, there may be the same number of the second feed channels 912 as through-holes 206. Additionally or alternatively, there may be half as many second feed channels 912 as first feed channels 910. The second feed channels 912 may be radially aligned with the corresponding through-holes 206, similar to the feed channels 212 of the stator 200. Thus, the second feed channels 912 may be interposed between pairs of the first feed channels 910. The second feed channels 910 may be located radially more inward than the first feed channels 910, at the base of the lobes 204. For example, the first feed channels 910 may be further from the axis 199 than the second feed channels 912. The second feed channels 912 may have cross sections of similar shape (e.g., curved and elongated in the radial directions) to the coolant channels 210 of the stator 200 as described above. The cross sectional areas of the second feed channels 912 may be smaller than those of the first feed channels 910.

The first and second feed channels 910, 912 located within the same lobe 204 may be fluidly coupled so as to allow fluid exchange therebetween. Alternatively, the first and second feed channels 910, 912 may each be fluidly separate from each other such that fluid in the feed channels 910, 912 may not flow from one of the feed channels 910, 912 into another different one of the feed channels 910, 912. In the example shown in FIG. 9, there is a combination of fluidly coupled and fluidly separate feed channels 910, 912. To elaborate, a first portion of the lobes 204 comprise fluidly coupled feed channels 910, 912, and a second portion of the lobes 204 comprise fluidly separate feed channels 910, 912. As an example, a first group 942 of feed channels 910, 912 located within a first lobe 204a are fluidly coupled to each other via connecting segments 944. The connecting segments 944 may extend radially and circumferentially to fluidly couple the first feed channels 910 with the corresponding second feed channel 912 positioned therebetween. A second group 946 of the feed channels 910, 912 located within a second lobe 204b may be fluidly separate from each other such that a space 948 (e.g., filled by the lamination layer material) is maintained between the feed channels 910, 912 of the second group 946 along the entire axial length of the stator 900. In this way, fluid entering first feed channels 910 that are fluidly separate from the second feed channels 912, such as a first first feed channel 910a, may follow the one available pathway axially therethrough, without flowing into another of the coolant channels 210. In the example shown, the groups of feed channels 910, 912 that are fluidly coupled and fluidly separate alternate circumferentially. In other examples, the groups of feed channels 910, 912 of each lobe 204 may all be interconnected, for example via the connecting segments 944 or other passages. In other examples, all of the feed channels 910, 912 may be fluidly separate from each other. Coolant may be delivered to the openings (e.g., inlets) of the feed channels 910, 912 at one or both of the first end 292 and the second end 294. The coolant fluid may axially traverse the stator 900 via the feed channels 910, 912, and may further be distributed throughout the stator via additional coolant channels 210 which branch off from the feed channels 910, 912.

In addition to the feed channels 910, 912, the coolant channels 210 may further include first cross channels 914 and second cross channels 916. The first cross channels 914 may extend circumferentially by an angular length 954 and the second cross channels 916 may each extend circumferentially by an angular length 956. The lengths 954, 956 may vary throughout the stator 900 such that the cross channels 914, 916 are sized differently than each other, or may be approximately the same such that the cross channels 914, 916 are all approximately the length as each other. An axial width 962 of the first cross channels 914 may be approximately the same as an axial width 964 of the second cross channels 916 such that the cross channels 914, 916 have approximately the same cross sectional areas. Alternatively, the widths 962, 964 may vary, for example increasingly with distance from the feed channels 910, 912.

The cross channels 914, 916 may be arranged in one or more rings axially spaced away from one another, such as a first ring 932, a second ring 934, and a third ring 936. The first ring 932 is axially closer to the first end 292 than the second ring 934 and the third ring 936. The second ring is axially closer to the second end 294 than the first ring 932 and the second ring 934. The second ring 934 is interposed between the first ring 932 and the third ring 936. The cross channels 914, 916 may be staggered along the rings rather than forming a continuous circumferential pathway. For example, each of the rings 932, 934, 936 of the cross channels 914, 916 may include a set of the first cross channels 914 and a set of the second cross channels 916. The set of the first cross channels 914 and the set of the second cross channels 916 may be arranged in an alternating pattern around the rings 932, 934, 936. The set of the first cross channels 914 may be at the same first axial position (e.g., same distances from the first end 292 and the second end 294) as each other, and the set of the second cross channels 914 may be at the same second axial position as each other. The second axial position may be different than the first axial position. For example, in each of the rings, the set of the first cross channels 914 may be closer to the first end 292 than the set of the second cross channels 916. As such, the set of second cross channels 916 may be closer to the second end 294 than the set of the first cross channels 914. In other words, the first and second cross channels 914, 916 may be axially offset from each other. An axial distance 960 by which centers of the set of the first cross channels 914 and the set of the second cross channels 916 of a given ring are axially offset from each other (e.g., difference between the first axial position and the second axial position) may be even throughout the stator 900 (e.g., the same for each of the rings 932, 934, 936). The axial distance 960 may be approximately the same as or less than one or both of the axial widths 962, 964.

Further, the first cross channels 914 and the second cross channels 916 may be circumferentially offset from each other. For example, the first cross channels 914 and the second cross channels 916 may axially overlap (e.g., overlap when looking down the axis 199) along a circumferential distance less than their circumferential lengths 954, 956, or not at all. The rings 932, 934, 936 may be axially distributed throughout the axial length 226 of the stator 900. For example, the rings 932, 934, 936 may be axially distributed symmetrically with respect to the axial middle of the stator 900. For examples where there are an odd number of rings of the cross channels 914, 916, one of the one of the rings (e.g., the second ring 934) may be positioned at the axial middle of the stator 900, similar to the cross channels 214, 216 of the stator 200. For examples where there are an even number of rings of the cross channels 914, 916, the two rings closest to the axial middle of the stator 900 may be equidistant from the axial middle so as to be symmetrically positioned with respect to the axial middle. Additionally or alternatively, the rings 932, 934, 936 may be axially equidistant from each other. For example, a first second cross channel 916a of the first ring 932, a second second cross channel 916b of the second ring 934, and a third second cross channel 916c of the third ring 936 may be axially equidistantly spaced away from each other. As such, the corresponding first cross channels of the rings 932, 934, 936 may be axially equidistantly spaced away from each other. Further, the second cross channels 916 may not be circumferentially offset from each other. Likewise, the first cross channels 914 may not be circumferentially offset from each other. For example, looking down the axis 199, the first cross channels 914 may overlap with each other along the entire angular length 954, and the second cross channels 916 may overlap along the entire angular length 956.

The cross channels 914, 916 may not be directly fluidly coupled with each other. The cross channels 914, 916 may be fluidly coupled to each other via the feed channels 910, 912 and/or other channels of the coolant channels 210 described below (e.g., axially extending channels). The connecting segments 944 may extend between the cross channels 914, 916 and the feed channels 910, 912, fluidly coupling the cross channels 914, 916 and the feed channels 910, 912. For example, the connecting segments 944 may each include a radial ramped wall 940 that extends between one of the cross channels 914, 916 and one of the first feed channels 910, such as a first first cross channel 914a and a second first feed channel 910b. The radial ramped walls 940 may be angled so as to be furthest radially outward at the intersection with the corresponding first feed channel 910 and furthest radially inward at the intersection with the corresponding cross channel 914, 916.

In other examples, each of the rings of cross channels may include three or more sets of cross channels, where channels within each set are at the same axial position as each other and a different axial position than channels of the other sets. For example, a ring of cross channels may comprise a pattern of first cross channels 914, second cross channels 916, and third cross channels repeating circumferentially, where the third cross channels are closer to or further from the first end 292 than the first cross channels 914 and/or the second cross channels 916. The rings of cross channels are shown identical in FIG. 9, though the cross channels may be arranged in rings differently from each other such as in different numbers of sets per ring, different cross sectional areas of the cross channels (e.g., increasing with distance from inlets of the feed channels), etc.

The coolant channels 210 may further include first axial channels 918 and second axial channels 920. The first axial channels 918 may be open to the first end 292 and the second axial channels 920 may be open to the second end 294. More specifically, the first axial channels 918 may extend from the cross channels 914, 916 to the first end 292, and the second axial channels 920 may extend from the cross channels 914, 916 to the second end 294. The coolant channels 210 may further include intermediate axial channels 922 in examples including more than one ring of the cross channels 914, 916. The intermediate axial channels 922 may extend between the rings 932, 934, 936 of the cross channels 914, 916 such that the cross channels 914, 916 of different rings are fluidly coupled to each other via the intermediate axial channels 922. As such, the intermediate axial channels 922 may be axially interposed between the first axial channels 918 and the second axial channels 920. There may be one or more sets of intermediate axial channels 922 according to the number of rings of the cross channels 914, 916, where intermediate axial channels 922 within each set have approximately the same axial position. In the example shown in FIG. 9, there are two sets of intermediate axial channels 922: a first set extending between the first ring 932 and the second ring 934 including a first intermediate axial channel 922a, and a second set extending between the second ring 934 and the third ring 936 including a second intermediate axial channel 922b. In any example, there may be one fewer sets of intermediate axial channels 922 than the number of rings of the cross channels 914, 916. Thus, in examples where there is a single ring of cross channels, such as in the stator 200 described above, the intermediate axial channels may not be included.

There may be equal numbers of the first axial channels 918 and the second axial channels 920. Further, there may be equal numbers of the intermediate axial channels 922 in each set thereof. In some examples, the first axial channels 918, the second axial channels 920, and the intermediate axial channels 922 may be circumferentially aligned such that continuous linear channels each comprising one of the first axial channels 918, one of the second axial channels 920, and one or more of the intermediate axial channels 922 extend entirely through the axial length 226 between the first end 292 and the second end 294. As an example, a continuous linear axial channel 950 comprises a first first axial channel 918a, the first intermediate axial channel 922a, the second intermediate axial channel 922b, and a first second axial channel 920a. Alternatively, the axial channels 918, 920, 922 may be circumferentially offset (e.g., like the axial channels 218, 220 described above) such that, other than the feed channels 910, 912, linear axial coolant pathways extending entirely through the axial length 226 are not included.

A circumferential width 972 of the first axial channels, a circumferential width 974 of the intermediate axial channels 922, and a circumferential width 976 of the second axial channels 920 may be approximately the same for each of the axial channels 918, 920, 922. Alternatively, the widths and/or the cross sectional areas of the axial channels 918, 920, 922 may vary throughout the stator 900. For example, the widths 972, 974, 976 may increase with distance from the feed channels 910, 912. Additionally or alternatively, the width 972 may be greater than or less than the width 974, and greater than or less than the width 976. As an example, the widths 972, 976 of the first and second axial channels 918, 920 may be greater than the width 974 of the intermediate axial channels 922. Additionally or alternatively, the widths 972, 974, 976 may be different in a region of the stator 900 submerged in coolant fluid accumulated in a sump below (e.g., in a relatively negative z-direction) the stator 900 (e.g., similar to the region 314 of FIG. 3). The axial widths 962, 964 of the cross channels 914, 916 may vary similarly, for example with increasing distance from the feed channels 910, 912 and/or by region (e.g., such as submerged or not submerged in coolant fluid). In this way, fluid flow (e.g., volumetric flow rate, velocity, etc.) through the axial channels 918, 920, 922 and/or the cross channels 914, 916 may be adjusted according to the cross sectional area variations of the coolant channels 210. Thus, the pattern of fluid flow may be tuned to the thermal profile of the stator 900 to counteract uneven heat generation by providing more coolant fluid to areas that tend to have relatively higher temperature during operation.

The axial channels 918, 920, 922 and the second feed channels 912 may be evenly radially arranged (e.g., equidistantly circumferentially spaced from each other). The axial channels 918, 920, 922 may all be a distance 968 from the outer perimeter 322, where the distance is sized such that the axial channels 918, 920, 922 are the at the same radial distance from the axis 199 as the second feed channels 912. Due to the cross channels 914, 916 and the second feed channels 912 being arranged concentrically (e.g., at the same radial distance from the axis 199) in some examples, the second feed channels 912 may directly intersect some of the cross channels 914, 916. Said another way, the cross channels 914, 916 may branch off from the second feed channels 912. Further, the cross channels 914, 916 may be spaced from the outer perimeter 322 by approximately the same distance 968. Thus, the axial channels 918, 920, 922, the second feed channels 912, and the cross channels 914, 916 may be located radially inward compared to the first feed channels 910 and the through-holes 206.

The axial channels 918, 920, 922 may intersect the rings 932, 934, 936 of the cross channels 914, 916 such that the cross channels 914, 916 fluidly couple the parallel axial channels 918, 920, 922. Specifically, the axial channels 918, 920 may intersect the rings 932, 934, 936 of the cross channels 914, 916 such that the first and second axial channels 918, 920 are each directly fluidly coupled to a single first cross channel 914 and a single second cross channel 916. As an example, the first axial channel 918a may intersect a first second cross channel 916a of the first ring 932, and no other second cross channels 916 of the first ring 932. Similarly, a second second axial channel 920b may intersect a third second cross channel 916c of the third ring 936, and no other second cross channels 916 of the first ring 932. Additionally, the intermediate axial channels 922 may each be directly fluidly coupled to two of each of the first cross channels 914 and the second cross channels 916. The axial channels 918, 920, 922 may not intersect the feed channels 910, 912 as the axial channels 918, 920, 922 and the feed channels 910, 912 may be linear and arranged parallel to each other and the axis 199. Said another way, the axial channels 918, 920, 922 may not be directly fluidly coupled to the feed channels 910, 912. However, the axial channels 918, 920, 922 may be fluidly coupled to each other, the second feed channels 912, and up to all of the first feed channels 910 (e.g., according to whether the connecting segments 944 are included at none, some, or all of the lobes 204), via the cross channels 914, 916 (and the connecting segments 944 if included). In this way, the first and second axial channels 918, 920 may branch off from the cross channels 914, 916 which are arranged at or in proximity to the axial middle of the stator to the respective ends 292, 294. Thus, coolant fluid may exit the stator 900 from the axial channels 918 via outlets at the first end 292 and/or the second end 294. Additionally or alternatively, coolant fluid may enter the stator 900 via the axial channels 918.

Coolant fluid may flow in similar pathways through the stator 900 as the pathways indicated by arrows 402 through stator 200 shown in FIG. 4 and described above. For example, after entering the stator 900 through the feed channels 912, the coolant fluid may flow into and through the cross channels 914, 916 directly fluidly coupled to the feed channels 912. From those cross channels 914, 916, coolant fluid may flow directly out of the stator via the axial channels 918, 920 directly fluidly coupled thereto, or prior to exiting the stator 900 via the first and second axial channels 918, 920, the coolant fluid may flow through one or more additional coolant channels 210.

Adjacent coolant channels 210 are shown spaced relatively further apart from each other in the stator 900 compared to the stator 200. However, it will be understood that the coolant channel pattern shown in FIG. 9 may be adjusted (e.g., by increasing a number of coolant channels) to position the coolant channels closer together than shown. For example, the circumferential lengths 954, 956 may be decreased, and accordingly, a greater number of axial channels 918, 920, 922 may be included. Likewise, the coolant channel pattern of the stator 200 may be spread out by decreasing the number of one or more of the axial and/or circumferential coolant channels.

By including more than one ring of cross channels, a circumferential grid pattern may be formed with non-linear (e.g., staggered, waved, etc.) circumferential coolant paths (e.g., through the cross channels 914, 916) and linear or non-linear axial coolant paths (e.g., through the axial channels 918, 920, 922 and the second feed channels 912). Such a coolant channel 210 configuration may be manufactured similarly to as described above with reference to the stator 200, with lamination layers of the stator 900 having identical inner and outer perimeters and each having one of a plurality of hole patterns which align (e.g., axially overlap) when stacked along the axis 199 to form the coolant channels 210.

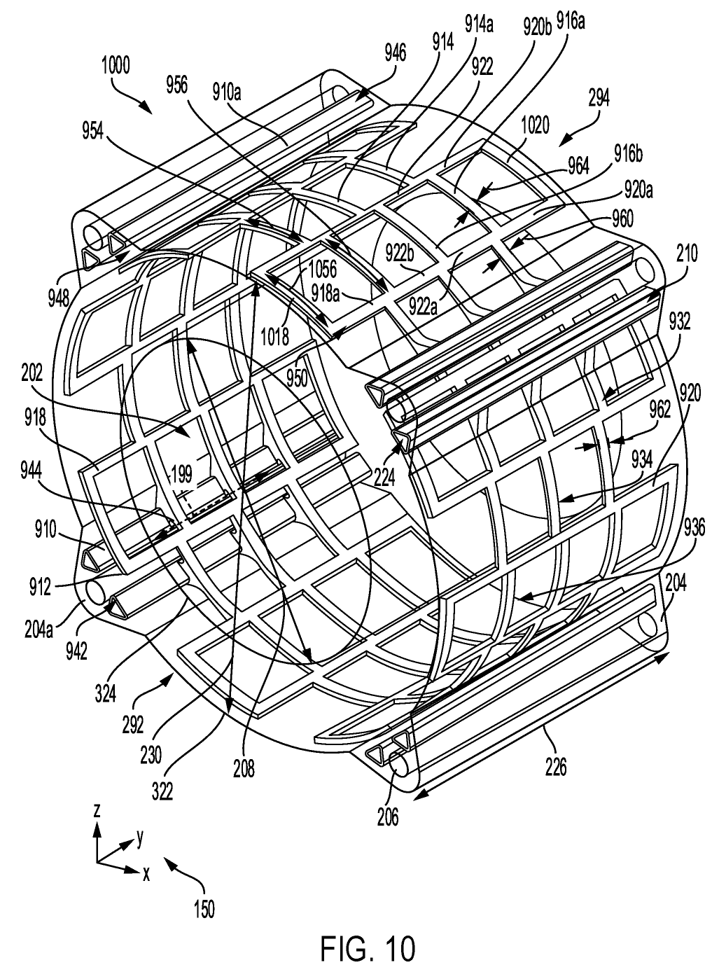

FIG. 10 shows a bolted stator 1000, which is another example of the stator 106 of FIG. 1. The stator 1000 comprises at least some of the coolant channels 210 of the stator 900, including the feed channels 910, 912, the cross channels 914, 916, and the axial channels 918, 920, 922. The coolant channels 210 further include return channels 1018, 1020. In this way, rather than fluid exiting the stator 1000 via the first and/or second axial channels 918, 920, the fluid may flow into the return channels 1018, 1020, respectively, and return to the cross channels 914, 916. Therefore, fluid may circulate throughout the stator 900, entering and exiting only through openings of the first feed channels 910 to one or both of the ends 292, 294. In this way, the axial channels 918, 920 are not open to either of the ends 292, 294.

The return channels 1018, 1020 may be the same length as the cross channels 914, 916. For example, a circumferential length 1056 of the first return channels 1018 may be approximately the same as the circumferential length 956 of the second cross channels 916 and/or the circumferential length 954 of the first cross channels 914. The lengths 954, 956, 1056 may also be equal to the distance between adjacent axial channels. The return channels 1018, 1020 may also have the same cross section shape and/or size as the cross channels 914, 916. However, the intersections between the return channels 1018, 1020 and the respective axial channels 918, 920 may be corners (e.g., 90-degree bends), in contrast with the four way branched intersections between the axial channels 918, 920, 922 and the cross channels 914, 916.

The return channels 1018, 1020 are shown axially aligned with the second cross channels 916. However, the return channels 1018, 1020 may instead be axially aligned with the first cross channels 914. Alternatively, the return channels may form a full ring axially aligned with both of the first and second cross channels 914, 916 such that instead of closed loops (e.g., comprised of the return channels 1018, 1020 and the respective axial channels 918, 920) extending beyond the rings of cross channels 914, 916 to the ends 292, 294, the staggered grid pattern may be continued. Return channels may also be included in examples with a single ring of cross channels, such as the stator 200 such that fluid is not allowed to exit via the axial channels.

Turning to FIGS. 5A and 5B, a coolant distribution element 500 is shown in a first view 510 and a second view 520, respectively. More specifically, a housing side 502 of the coolant distribution element 500 is shown in the first view 510 and a stator side 504 of the coolant distribution element 500 is shown in the second view 520. The housing side 502 where the coolant distribution element 500 is configured to be in face sharing contact with a housing (e.g., housing 110 of FIG. 1) and the stator side 504 where the coolant distribution element 500 is configured to be in face sharing contact with a bolted stator housed by the housing (e.g., stator 106 of FIG. 1) may be opposite axial sides of the coolant distribution element 500.

The coolant distribution element 500 may be shaped according to the bolted stator. For example, the coolant distribution element 500 may include a ring or annular shape having an outer perimeter 506 and an inner perimeter 508 sized according to the outer perimeter and the inner perimeter, respectively, of the stator (e.g., outer perimeter 322 and inner perimeter 324 of FIGS. 3, 4, and 8-10). For example, an inner diameter 512 of the inner perimeter 508 may be approximately the same as or larger than the diameter of the stator bore (e.g., bore diameter 208 of the bolted stators 200, 800, 900, 1000). Additionally, an outer diameter 514 of the outer perimeter 506 may be less than or equal to the outer diameter of the annular portion of the stator (e.g., diameter 230).

The coolant distribution element 500 may further include radial extensions 516, shaped and arranged according to the lobes 204 and bolts (e.g., bolt 602 of FIG. 6) which extend through the through-holes 206 therein. For example, there may be the same number of extensions 516 as one or more of lobes 204, through-holes 206, bolts, and feed channels 212. The radial extensions 516 may be radially aligned with the corresponding lobes 204. Bolt pockets 518 positioned at the radially outer ends of the radial extensions 516 may provide space for heads 606 of the bolts 602 shown in FIG. 6. The bolt pockets 518 may extend from the stator side 504 towards the housing side 502, but may not reach the housing side 502. Thus, the bolt pockets 518 may be shorter in the y-direction than the radial extensions 516. The bolt pockets 518 may determine the orientation of the coolant distribution element 500 relative to the stator 200. For example, the bolt pockets 518 interacting with the bolts 602 may ensure the coolant distribution element 500 does not rotate (e.g., about the rotational axis 199) relative to the stator 200. In this way, the bolt pockets 518 receiving the bolts 602 may positionally locate the coolant distribution element 500 relative to the stator during assembly. Additionally, the coolant distribution element 500 may include indents 552 extending circumferentially between the extensions 516.

The coolant distribution element 500 may further include one or more grooves configured to fit with complementary protrusions (e.g., protrusion 232 of FIGS. 2 and 8) to form one or more press in place seals. For example, the coolant distribution element 500 may include a first groove 522 in proximity to the outer perimeter 506 on the housing side 502 and a second groove 524 in proximity to the inner perimeter 508 on the housing side 502. The coolant distribution element 500 may further include a third groove 526 in proximity to the outer perimeter 506 on the stator side 504. The grooves 522, 524, 526 may be interference fitted with complementary protrusions of the housing and the stator, as described further below with regard to FIG. 6. Protrusions of PIP seals are not shown in FIGS. 9 or 10 for clarity. However, protrusions may be included that are complementary to (e.g., able to form a press in place seal with) grooves of the coolant distribution element positioned on the stator side, such as the groove 526 of the coolant distribution element 500.

In other examples, the coolant distribution element 500 may comprise protrusions complementary to grooves formed in the housing and the stator. The grooves 522, 524, 526 may be spaced away from the respective perimeters by a fixed distance such that the grooves 522, 524, 526 outline the same shape with a slightly different size. For example, the groove 524 may outline a circular shape with a slightly larger diameter than the inner perimeter 508. As another example, the first groove 522 may trace along the outer perimeter 506 with a generally circular shape having curves which accommodate the extensions 516. There may not be a seal along the inner perimeter 508 on the stator side 504. The grooves 522, 524, 526 may have rectangular cross sections such that the grooves 522, 524, 526 are adapted to receive complementary protrusions having rectangular cross sections.

A housing side cavity 532 may be bordered by one or more surfaces of a housing (e.g., housing 110 of FIG. 1) positioned in face-sharing contact with the coolant distribution element 500 at the grooves 522, 524, and a housing side surface 528 of the coolant distribution element 500 radially interposed between the first groove 522 and the second groove 524. In this way, the housing side cavity 532 may be similar to a torus shape. Likewise, a stator side cavity 534 may be bordered by one or more surfaces of a stator positioned in face-sharing contact with the coolant distribution element 500, a stator side surface 538 of the coolant distribution element 500, and a radially inward facing surface 536 of the coolant distribution element 500.

The coolant distribution element 500 may further include feed ports 548. The feed ports 548 may be open to the stator side 504 at stator side openings 544 and open to the housing side 502 via housing side openings 542. For example, each feed port 548 may include one housing side opening 542 and two stator side openings 544. The housing side opening 542 may be in fluid communication with the corresponding stator side openings 544 via a branched channel extending through the extension 516. In this way, the coolant distribution element 500 may be configured to distribute coolant fluid.

Protrusions 546 may protrude from the stator side 504 and border the stator side openings 544. The groove 526 may surround the protrusions such that a complementary rib of the stator may fit into the groove 526 to form a press in place seal around the stator side openings 544. Thus, coolant fluid may not be allowed to flow directly from the feed ports 548 to the stator side cavity 534 (e.g., radially inward) or directly from the feed ports 548 to the bolts received by the bolt pockets 518 (e.g., radially outward). The protrusions 546 may be shaped according to the extensions 516 and the groove 526. More specifically, the protrusion 546 may be shaped such that the groove 526 is approximately the same thickness throughout the coolant distribution element 500. For example, the protrusion 546 may include a first portion shaped as a circular arc parallel with the inner perimeter 508 and a second portion intersecting the first portion and shaped parallel with the outer perimeter 506 of the extensions 516.

The coolant distribution element 500 may further comprise one or more drain ports 540. The drain ports 540 may be located at a vertical bottom of the coolant distribution element 500 so as to be configured to allow coolant fluid drainage therethrough. For example, coolant fluid in the stator side cavity 534 may flow downwards through the drain ports 540 to a reservoir (e.g., sump). The drain ports 540 may be circumferentially offset from the extensions 516. The drain ports 540 may be rectangular with rounded corners, as an example. However, the shape and size of the drain ports 540 may be different according to a desired flow pattern and/or flow rate therethrough.

The coolant distribution element 500 may further comprise a plurality of radially arranged holes 570, as shown in a third view 530 in FIG. 5C. The holes 570 may be shaped and arranged similar to jets of a showerhead such that the coolant distribution element 500 is configured as a shower head baffle. For example, the holes 570 may have small diameters, such as on the order of millimeters or smaller. The holes 570 may be equidistantly spaced from one another along a portion of the circumference along which they are arranged. For example, there may not be holes 570 included below a vertical height indicated by the line 560. As an example, the line 560 may mark the top of a coolant submerged region such as the region 314 of FIG. 3. By not including holes 570 below the height indicated by the line 560, more coolant fluid may be distributed to areas above the height, and may subsequently passively flow downwards due to gravity to the areas below the height. The holes 570, if included, may fluidly couple the stator side cavity 534 with the housing side cavity 532 for further distribution of coolant fluid throughout a system comprising the coolant distribution element 500 and a bolted stator as described further below. For example, coolant pressurized through the holes 570 may spray windings of the bolted stator.

The coolant distribution element 500 may be shaped according to the coolant channels of the bolted stator. More specifically, the coolant distribution element may take different shapes corresponding to the feed channels of the bolted stator. The coolant distribution element 500 as shown may be compatible with the stator 900 of FIG. 9 or the stator 1000 of FIG. 10 due to the corresponding geometry of the feed channels 910 and the feed ports 548. With modifications to shape and/or dimension, the coolant distribution element may be compatible alternatively with the stator 200 of FIGS. 2-4 or the stator 800 of FIG. 8. For example, the protrusions 546 and the groove 526 may be shaped complementary to the protrusions 232 of FIG. 2 or 8 in order for the coolant distribution element 500 to form press in place seals with the stator 200 or 800, respectively. As such, in some examples, such as in cases where there is one feed channel per lobe, the feed ports 548 may include only one stator side opening 544 per feed port 548. Alternatively, there may be more than two stator side openings 544 per feed port 548, in examples where distribution to more than two feed channels is demanded.

Turning to FIG. 6, a portion of a stator assembly 600 comprising the stator 106 (e.g., the bolted stator 900 or 1000) and the coolant distribution element 500 is shown in a cross sectional view 610. The assembly 600 may be included in an electric machine, such as the electric machine 100 of FIG. 1. The electric machine including the assembly 600 may be included in a system (e.g., vehicle) further comprising a gearbox (e.g., transmission) such as shown in FIG. 11 and described below.

An example of the rotor 104 of FIG. 1 is also shown in FIG. 6. The rotor 104 may include one or more of a rotor core 614 comprising lamination layers, an end plate 626 at one or both ends of the rotor core 614, and one or more through-holes 628 extending through the end plate(s) 626 and/or the rotor core 614. The rotor 104 may be circumferentially surrounded by the stator 106 with a gap 640 therebetween. The coolant distribution element 500 may be axially spaced away from the rotor 104 by a distance 624.

The coolant distribution element 500 is shown positioned at one end of the stator. However, it will be understood that a second coolant distribution element (e.g., a baffle) identical to or different from the coolant distribution element 500 may be positioned at the opposite axial end of the stator 106 and sealed thereto via another press in place seal (e.g., seal comprising complementary protrusions and grooves interference fitted with each other) or other sealing means. Further, as noted above, the geometry of the feed ports 548 may be adjusted for different feed port arrangements.

A press in place seal may be formed by the groove 526 interference fitting with a protrusion 612 of the stator 106 shaped complementarily. As used herein, complementarily shaped protrusion and grooves may have identical cross section shapes with the groove being negative space filling the cross section shape and the protrusion being positive space filling the cross section shape. In this way, the groove 526 and the protrusion 612 may form a press in place seal bordering the inlet 224 of the feed channel (e.g., feed channels 212 of FIG. 2, feed channels 910, 912 of FIGS. 9 and 10). The protrusion 612 may be an example of the protrusion 232 of FIGS. 2-4 having a different shape than shown therein according to the groove 526 of the coolant distribution element 500. The housing side cavity 532 may be enclosed when a housing (e.g., housing 110 of FIG. 1) is assembled with the coolant distribution element 500. For example, the grooves 522, 524 and complementary protrusions of a housing (e.g., housing 110) may be interference fitted to form press in place seals enclosing the housing side cavity 532, as shown in FIG. 11. The press in place seals may be maintained without fasteners (e.g. bolts, screws, or the like). For example, the interference fit may apply enough force between surfaces of the grooves and protrusions to maintain hermetic seals at the grooves 522, 524, 526. Additional axial support to the press in place seals may be provided when the housing is secured (e.g., bolted) in place on the housing side 502. That is, compressive forces of fastening systems for holding the housing in place may further secure the seals by reducing a likelihood of separation (e.g., leading to seal leakage) or degradation (e.g., vibrational movement degrading the groove and protrusion materials).

Coolant fluid may be delivered to the housing side cavity 532 via a pump of a cooling system such as the cooling system 122 of FIG. 1. The housing side cavity 532 being torus shaped may allow coolant fluid to be radially distributed to each of the feed ports 548. Edges 622 of the housing side opening 542 may be curved such that flow of fluid into the feed ports 548 from the housing side cavity 532 is more smooth, compared to fluid flow over sharp corners.

Coolant fluid may flow through the feed ports 548, including the housing side openings 542 and the stator side openings 544, to reach the coolant channels 210 of the stator 106. More specifically, from the feed ports 548, the coolant fluid may flow into the feed channels (e.g., feed channels 212, 910, or 912). In examples where there is more than one feed channel per lobe, having more stator side openings 544 than housing side openings 542 may distribute coolant fluid evenly to each of the feed channels. In this way the feed ports 548 may be directly fluidly coupled to the feed channels and in fluid communication with the rest of the coolant channels 210 (e.g., axial channels 218, 220 and cross channels 214, 216, or axial channels 918, 920, 922 and cross channels 914, 916) via the feed channels. The feed ports 548 may be a different shape or relative size than shown according to desired flow rates and flow patterns as well as the coolant channels 210 configuration. From the feed channels, the coolant fluid may be distributed throughout the stator 106 via the axial channels and circumferential cross channels such as described above.

Outlets (e.g., outlets 418 and 420 of FIG. 4 or outlets 988, 990 of FIG. 9) of the coolant channels 210 may allow fluid to exit the stator 106 at one or both axial ends thereof (e.g., ends 292, 294 shown in FIGS. 2, 4, 8, 9 and 10), for example including into the stator side cavity 534. Thus, the fluid may exit the stator 106 axially. There may not be outlets which allow coolant fluid to exit the stator 106 radially. For example, there may not be any openings along the outer cylindrical surface of the stator 106. Ends of stator windings 604 may be positioned within the stator side cavity 534. Thus, in addition to cooling the lamination layers of the stator 106 by flowing through the coolant channels 210, the coolant fluid may also cool the windings 604 by flowing therearound. As described above, a shower head baffle may be positioned at the outlets to spray the coolant fluid more evenly among the windings 604. Additionally or alternatively, the coolant distribution element 500 having radially arranged holes 570 may be configured as a shower head baffle wherethrough coolant fluid is sprayed from the housing side cavity 532 into the stator side cavity 534.

Briefly turning to FIG. 12, an example of the coolant distribution element 500 assembled with the stator 106 and the housing 110 is shown, where the coolant distribution element 500 includes the holes 570. Thus, in addition to pressurized coolant fluid flowing from the housing side cavity 532 to the feed channels via the feed ports 548, the coolant fluid may be forced through the holes 570 from the housing side cavity 532 to the stator side cavity 534, spraying the ends of the windings 604 positioned therein. Alternatively, the coolant distribution element 500 may not include holes fluidly coupling the stator side cavity 534 and the housing side cavity 532, and fluid surrounding the windings 604 may be delivered via the outlets of the coolant channels 210 only. The coolant channels 210 are omitted from FIG. 12 for generalization of the stator 106 to include any of the examples described herein with different coolant channel geometry (e.g., different quantities, shapes, and relative positions) such as the stator 200 of FIGS. 2-4, the stator 800 of FIG. 8, the stator 900 of FIG. 9, or the stator 1000 of FIG. 10.

Returning to FIG. 6, in some examples, the assembly 600 may be configured such that coolant fluid may not be allowed to flow from the stator side cavity 534 into the bore 202 to prevent the coolant fluid from causing drag losses on rotation of the rotor 104. For example, another seal (e.g., press in place seal) extending circumferentially may be radially interposed between the inner perimeter 324 and the windings 604 (e.g., positioned radially inward of the windings and radially outward of the inner perimeter 324). The seal may be formed by additional complementary grooves and protrusions in the stator 106 and the coolant distribution element 500, or any other sealing systems (e.g., gasket, O-ring, etc.). An additional seal may be positioned at the opposite axial end. In this way, coolant fluid may be sealed from entering the bore 202. Whether the stator side cavity 534 is sealed from or fluidly coupled with the bore 202, the coolant fluid may flow out of the stator side cavity 534 via drain ports such as the drain ports 540 shown in FIG. 5B. As an example, the drain ports 540 may lead to a sump. The stator 106 may be partially submerged in the coolant fluid accumulated in the sump, as described with regard to FIG. 3. Alternative to flowing out via the drain ports, the coolant fluid may return to the stator 106 in a closed loop system wherein coolant fluid circulates continuously through the stator 106 and the coolant distribution element 500.

In an open system where coolant fluid is allowed to exit the assembly 600 (e.g., via drain ports), the coolant fluid may further be delivered to the rotor 104 from the stator side cavity 534. Further still, coolant fluid may be delivered to a gear spray bar which distributes the coolant fluid among components external to the assembly 600.

For example, turning to FIG. 11, a transmission system 1100 is shown including an example of the electric machine 100 and a gearbox 1102 (e.g., transmission) comprising gears 1106 rotationally coupled to the rotor shaft 108 and housed by a gearbox housing 1110. The coolant channels 210 are omitted from FIG. 11 for generalization of the stator 106 to include any of the examples described herein with different coolant channel geometry such as the stator 200 of FIGS. 2-4, the stator 800 of FIG. 8, the stator 900 of FIG. 9, the stator 1000 of FIG. 10, and variations thereof. The transmission system 1100 may be included in the system 102 of FIG. 1.

The gears 1106 and shafts of the gearbox 1102 may be driven by torque generated by the electric machine 100. For example, rotation of the rotor shaft 108 may cause rotation of components of the gearbox 1102 which may transfer torque to drive wheels, thereby providing propulsion to a vehicle including the system 1100. The gearbox housing 1110 may be integral with the housing 110 of the electric machine 100, in one example. Alternatively, the gearbox housing 1110 may comprise one or more parts permanently or separably fixed to the housing 110. The rotor shaft 108 may be physically supported by and rotationally decoupled from the housing 110 and the gearbox housing 1110 via one or more bearings 1104. Rotational decoupling may allow free rotation (e.g., with minimal friction) of the referenced components relative to each other.

As shown in FIG. 11, a spray bar 1122 may be fluidly coupled to both the housing side cavity 532 and the interior of the gearbox housing 1110 such that coolant fluid may flow from the housing side cavity 532 to components of the gearbox 1102, as indicated by arrows 1124. Thus, although the gearbox housing 1110 and/or the housing 110 may separate the coolant distribution element 500 and the stator 106 from the gears 1106 and shafts of the gearbox 1102, the housing side cavity 532 may be fluidly coupled to the interior of the gearbox 1102 via the spray bar 1122. In this way, the housing side cavity 532 which is formed by the press in place seals at the complementary groves and protrusions of the housing 110 and the coolant distribution element 500 may passively provide coolant fluid to both the stator 106 and the gearbox 1102. To elaborate, the press in place seals may allow pressurization within the housing side cavity 532 that forces the coolant fluid from the housing side cavity 532 through various parallel coolant fluid circuits, including one or more of a first pathway through the feed ports 548 to the coolant channels 210 of the stator 106, a second pathway through the holes 570 to the windings 604 of the stator 106, and a third pathway through the spray bar 1122 to the gearbox 1102, each of the aforementioned pathways originating in the housing side cavity 532.

In this way, the coolant distribution element 500 may distribute coolant fluid in more even amounts to the coolant channels of the stator 106. Further, returning to FIG. 6, the coolant distribution element 500 may seal the inlets to the feed channels (e.g., feed channels 212 of FIG. 2, feed channels 910, 912 of FIGS. 9 and 10) despite the presence of the bolts 602 in close proximity. Further still, the bolt pockets 518 may provide orientation control during assembly of the coolant distribution element 500 with the stator 106. For example, positioning the bolts 602 to be received by the bolt pockets 518 may inherently position the groove 526 and protrusion 546 to fit with the protrusion 612.

Turning to FIG. 7, a method 700 is shown for actively cooling a bolted stator, such as the bolted stator 106 and examples thereof including the bolted stator 200 of FIGS. 2-4, the bolted stator 800 of FIG. 8, the bolted stator 900 of FIG. 9, and the bolted stator 1000 of FIG. 10. The method 700 may be an active cooling method, wherein pressurized coolant fluid (e.g., oil) flows through channels within the bolted stator. Previous methods of cooling bolted stators may in contrast be passive cooling methods where coolant may not flow through the stator, for example due to previous seals used for active cooling being incompatible with bolt configurations. However, the placement of seals and coolant channels, as well as a coolant distribution element as described herein may allow for active cooling of bolted stators, such as via the method 700.

The method 700 begins at 702, wherein coolant fluid is delivered to a stator assembly comprising a coolant distribution element in face-sharing contact and sealed with the bolted stator, such as the coolant distribution element 500 of FIGS. 5A, 6, 11 and 12. For example, the cooling system 122 of FIG. 1 may deliver coolant fluid to the coolant distribution element. Specifically, the coolant pressurizing component 124 may pump fluid from the reservoir 128 (e.g., sump or other fluid container) to the housing side 502 of the coolant distribution element 500. Coolant fluid may be delivered continuously to the stator assembly. The coolant distribution element may be sealed with the bolted stator via one or more press in place seals formed by interference fitted complementary grooves and protrusions. The coolant distribution element may be further sealed with a housing at two circumferential locations to form a sealed cavity (e.g., housing side cavity 532). The coolant fluid may be pumped into the sealed cavity.

The method 700 proceeds to 704, wherein the coolant fluid is distributed throughout the bolted stator via the coolant distribution element and coolant channels of the bolted stator. For example, from the sealed cavity whereto the coolant fluid is pumped by the cooling system, the coolant fluid may be directed to one or more parallel coolant circuits, at least one of which extending through the stator. Additional cooling circuits may deliver coolant fluid to the rotor of the electric motor and the gears and shafts rotationally coupled to the rotor. Distributing the coolant fluid may occur passively due to the shape and arrangement of the coolant distribution element and coolant channels described herein. For example, briefly referencing FIGS. 2-6, the coolant distribution element 500 may guide fluid through the feed ports 548 to the feed channels 212 of the stator 200. From the feed channels 212, the fluid may be distributed throughout the stator 200 via the cross channels 214, 216 and the axial channels 218, 220. In another example, briefly referencing FIG. 9, from the feed channels 910, 912, the fluid may be distributed throughout the stator 900 via the cross channels 914, 916 and the axial channels 918, 920, 922. In another example, briefly referencing FIG. 10, from the feed channels 910, 912, the fluid may be distributed throughout the stator 1000 via the cross channels 914, 916, the axial channels 918, 920, 922, and the return channels 1018, 1020. In this way, the coolant fluid may follow paths extending in a combination of axial and circumferential directions within the stator 106.

The method 700 may further include 706, wherein the coolant fluid is collected in a reservoir by allowing the coolant to exit the stator assembly via outlets of the bolted stator and drain ports (e.g., drain ports 540 of FIG. 5B) of the coolant distribution element. For example, the reservoir may be a sump below the bolted stator. The drain ports may be located at the vertical bottom of the coolant distribution element in order to allow the coolant to exit the stator assembly to reach the reservoir. The fluid may be pumped from the reservoir back through the stator assembly, for example.

The method 700 may reduce heat of a bolted stator more than conventional cooling methods for bolted stators due to coolant fluid actively being pumped throughout the stator and distributed via cooling channels and the coolant distribution element.

The technical effect of the systems and methods for active cooling of a bolted stator disclosed herein is to reduce a temperature of the bolted stator. The configurations of coolant channels, seals, and a coolant distribution element allow coolant to flow through the stator with reduced likelihood of coolant leaks. For example, press in place seals comprising complementary protrusions and grooves may surround the inlets of the feed channels, sealing the coolant pathways from the bolts and the bore of the stator. Further, temperature throughout the stator may be relatively even due to the coolant distribution element and the coolant channels distributing the coolant fluid such that heat removed from the stator is maximized.

The disclosure also provides support for a bolted stator of an electric machine, comprising: a lobe wherethrough a bolt extends, a feed channel positioned at a base of the lobe, cross channels extending circumferentially at an axial middle of the bolted stator and in fluid communication with the coolant feed channel, and axial channels extending axially from the cross channels to a first end of the bolted stator and a second end of the bolted stator axially opposite the first end. In a first example of the system, the system further comprises: a press in place seal positioned around an inlet of the feed channel. In a second example of the system, optionally including the first example, cross sectional areas of the axial channels increase with distance from the coolant feed channel. In a third example of the system, optionally including one or both of the first and second examples, the bolted stator is symmetric across one or more radially oriented planes. In a fourth example of the system, optionally including one or more or each of the first through third examples, the axial channels include first axial channels and second axial channels on opposite sides from each other across the cross channels such that the first axial channels are open to the first end and the second axial channels are open to the second end. In a fifth example of the system, optionally including one or more or each of the first through fourth examples, the cross channels include first cross channels and second cross channels, and wherein the first cross channels are circumferentially offset from the second cross channels so as to each axially overlap with two or more of the second cross channels. In a sixth example of the system, optionally including one or more or each of the first through fifth examples, cross sectional areas of the axial channels within a portion of the bolted stator submerged in coolant fluid are smaller than the coolant channels vertically above the portion.

The disclosure also provides support for an electric machine, comprising: a rotor, a bolted stator comprising lamination layers held together via bolts extending through lobes radially arranged along an outer perimeter of the bolted stator, wherein coolant channels extend axially and circumferentially through the lamination layers, and a coolant distribution element in face-sharing contact with the bolted stator at a first end of the bolted stator and fluidly coupled to the coolant channels, the coolant distribution element comprising radial extensions protruding towards the bolts, wherein feed ports extend through the radial extensions from a stator side of the coolant distribution element and a housing side of the coolant distribution element axially opposite the stator side. In a first example of the system, the coolant channels extending circumferentially are positioned at an axial middle of the bolted stator. In a second example of the system, optionally including the first example, the coolant channels include feed channels radially aligned with the bolts and the radial extensions. In a third example of the system, optionally including one or both of the first and second examples, the coolant distribution element further comprises bolt pockets adapted to receive heads of the bolts. In a fourth example of the system, optionally including one or more or each of the first through third examples, the coolant distribution element is sealed to the bolted stator and a housing of the electric machine via one or more press in place seals. In a fifth example of the system, optionally including one or more or each of the first through fourth examples, the coolant distribution element further comprises drain ports. In a sixth example of the system, optionally including one or more or each of the first through fifth examples, the feed ports each include one housing side opening at the housing side and two stator side openings at the stator side. In a seventh example of the system, optionally including one or more or each of the first through sixth examples, there are inlets to the coolant channels at the first end and outlets from the coolant channels at both ends of the bolted stator.

The disclosure also provides support for a method of actively cooling a bolted stator, comprising: delivering pressurized coolant fluid to a stator assembly comprising a coolant distribution element in face-sharing contact and sealed with the bolted stator, and distributing the coolant fluid throughout the bolted stator via the coolant distribution element and coolant channels, wherein the coolant channels include cross channels extending circumferentially along an axial middle of the bolted stator, feed channels radially aligned with bolts of the bolted stator and extending axially from inlets to the cross channels, and axial channels extending axially from the cross channels to outlets radially arranged at both ends of the bolted stator. In a first example of the method, a seal between the bolted stator and the coolant distribution element is a press in place seal positioned along an outer perimeter of the coolant distribution element. In a second example of the method, optionally including the first example, the inlets are directly fluidly coupled to feed ports of the coolant distribution element and surrounded by a press in place seal comprising complementary protrusions and grooves. In a third example of the method, optionally including one or both of the first and second examples, at least some of the cross channels are directly fluidly coupled to the feed channels, and the axial channels are in fluid communication with the feed channels via the cross channels. In a fourth example of the method, optionally including one or more or each of the first through third examples, the method further comprises collecting the coolant fluid in a reservoir by allowing the coolant fluid to exit the stator assembly via drain ports of the coolant distribution element.

FIGS. 1-6 and 8-12 show schematics of example configurations with relative positioning of the various components. FIGS. 2-6 and 8-12 are shown approximately to scale; though other relative dimensions may be used. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

As used herein, the term “approximately” is construed to mean plus or minus five percent of the range unless otherwise specified.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A bolted stator of an electric machine, comprising:
a lobe wherethrough a bolt extends; and
coolant channels, including:
a feed channel positioned at a base of the lobe;
cross channels extending circumferentially, where the cross channels are arranged in one or more rings axially distributed symmetrically with respect to an axial middle of the bolted stator and in fluid communication with the feed channel; and
axial channels extending axially from the cross channels to a first end of the bolted stator and a second end of the bolted stator axially opposite the first end.

2. The bolted stator of claim 1, further comprising a press in place seal positioned around an inlet of the feed channel.

3. The bolted stator of claim 1, wherein cross sectional areas of the axial channels increase with distance from the feed channel.

4. The bolted stator of claim 1, wherein the bolted stator is symmetric across one or more radially oriented planes.

5. The bolted stator of claim 1, wherein the axial channels include first axial channels and second axial channels on opposite sides from each other across the axial middle.

6. The bolted stator of claim 1, wherein the cross channels include first cross channels and second cross channels, and wherein the first cross channels are circumferentially offset from the second cross channels so as to each axially overlap with none, two, or more of the second cross channels.

7. The bolted stator of claim 1, wherein cross sectional areas of the coolant channels within a portion of the bolted stator submerged in coolant fluid are smaller than the coolant channels vertically above the portion.

8. An electric machine, comprising:
a rotor;
a bolted stator comprising lamination layers held together via bolts extending through lobes radially arranged along an outer perimeter of the bolted stator, wherein coolant channels extend axially and circumferentially through the lamination layers; and
a coolant distribution element in face-sharing contact with the bolted stator at a first end of the bolted stator and fluidly coupled to the coolant channels, the coolant distribution element comprising radial extensions protruding towards the bolts, wherein feed ports extend through the radial extensions from a stator side of the coolant distribution element and a housing side of the coolant distribution element axially opposite the stator side.

9. The electric machine of claim 8, wherein at least some of the coolant channels extending circumferentially are positioned at an axial middle of the bolted stator.

10. The electric machine of claim 8, wherein the coolant channels include feed channels radially aligned with the bolts and the radial extensions.

11. The electric machine of claim 8, wherein the coolant distribution element further comprises bolt pockets adapted to receive heads of the bolts.

12. The electric machine of claim 8, wherein the coolant distribution element is sealed to the bolted stator and a housing of the electric machine via one or more press in place seals.

13. The electric machine of claim 8, wherein the coolant distribution element further comprises drain ports.

14. The electric machine of claim 8, wherein the feed ports each include one housing side opening at the housing side and one or more stator side openings at the stator side.

15. The electric machine of claim 8, wherein there are inlets to the coolant channels at the first end and outlets from the coolant channels at both ends of the bolted stator.

16. A method of actively cooling a bolted stator, comprising:
delivering pressurized coolant fluid to a stator assembly comprising a coolant distribution element in face-sharing contact and sealed with the bolted stator; and
distributing the coolant fluid throughout the bolted stator via the coolant distribution element and coolant channels, wherein the coolant channels include cross channels extending circumferentially and arranged in one or more rings axially distributed symmetrically with respect to an axial middle of the bolted stator, feed channels radially aligned with bolts of the bolted stator and extending axially from inlets to the cross channels, and axial channels extending axially from the cross channels to outlets or return channels radially arranged at both ends of the bolted stator.

17. The method of claim 16, wherein a seal between the bolted stator and the coolant distribution element is a press in place seal positioned along an outer perimeter of the coolant distribution element.

18. The method of claim 16, wherein the inlets are directly fluidly coupled to feed ports of the coolant distribution element and surrounded by a press in place seal comprising complementary protrusions and grooves.

19. The method of claim 16, wherein at least some of the cross channels are directly fluidly coupled to the feed channels, and the axial channels are in fluid communication with the feed channels via the cross channels.

20. The method of claim 16, wherein the method further comprises collecting the coolant fluid in a reservoir by allowing the coolant fluid to exit the stator assembly via drain ports of the coolant distribution element.
